(19) United States
(12) Patent Application Publication
(10) Pub. No.: US 2006/0059233 A1
(43) Pub. Date: Mar. 16, 2006

(54) Media data transmission apparatus and media data reception apparatus

(75) Inventors: Ichiro Takei, Tokyo (JP); Junichi Sato, Tokyo (JP); Takao Yamaguchi, Osaka (JP); Yuji Sato, Tokyo (JP); Tomoaki Itoh, Kanagawa (JP); Daiji Ido, Tokyo (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRILAL CO., LTD, OSAKA (JP)

(21) Appl. No.: 10/541,384

(22) PCT Filed: Jan. 21, 2004
(86) PCT No.: PCT/JP04/00501

§ 371 Date: Jul. 1, 2005

(30) Foreign Application Priority Data
Jan. 23, 2003 (JP) 2003-014580
Jun. 27, 2003 (JP) 2003-185529

(51) Int. Cl. G06F 15/16

(52) U.S. Cl. 709/206; 715/500

(57) ABSTRACT

In the present invention, content is comprised of a plurality of items of data, and a transmission cycle and others of data composing the content are varied corresponding to the importance and/or necessity and purpose of the data. In this way, for example, it is possible to set a shorter transmission cycle on high-necessity data than the transmission cycle of the low-necessity data, and to set a shorter transmission cycle on information such as summary information requiring fast viewing than the transmission cycle of detailed information.

### TECHNICAL FIELD

The present invention relates to a media data transmission apparatus and media data reception apparatus for transmitting/receiving content including a plurality of items of media data such as a program, image data, text data, speech data, music data, operation rule for specifying the operation of the program, and sub-program operating as part of the program.

### BACKGROUND ART

As a method for distributing a program to a reception terminal, there are a communication type of distribution method where a reception terminal connects to a program distribution server to download a program and a broadcast type of distribution method where a distribution server transmits data to a reception terminal in one direction, and the reception terminal receives the program.

The communication type of program distribution is effective in the case where programs for reception terminals to store differ between the terminals, and is a scheme ordinarily used on the current internet.

Meanwhile, in the broadcast type of program distribution, the transmission band can be used effectively as compared to the communication type when the same program is transmitted to a plurality of reception terminals, and a reception terminal is capable of recognizing promptly that distribution of a program is started (in the communication type, the reception terminal does not recognize whether distribution of a program is started without inquiring to the transmission terminal).

A conventional example of the broad type of program transmission is described in Non-Patent Document 1 (Tsutomu Terada et al. “Design and Implementation of an Active Database System for Receiving Broadcast Data”, D-1 Vol. J83-D-1, No. 12, pages 1272-1283, December 2000). In this example, instead of transmitting a program, by transmitting an operation rule (ECA rule) for specifying the operation of the program, it is possible to change the operation of the program.

In transmitting broadcast content (for example, media data such as video, audio, text and program) generally, there is a problem that as the transmission cycle is longer, the waiting time is increased for display or operation of the content. However, it is difficult to shorten the transmission cycle to all the content in the limited transmission band.

Therefore, a method is proposed of setting important content for a short transmission cycle. For example, in Non-Patent Document 2 (Masahiro AONO, el al. “Reducing Response Time by Integrated Push-pull Method”, Information Processing Society, Vol. 42, No. 6, pages 1694-1701 (2001)), a short transmission cycle is set on content with a high audience rate, and it is thereby possible to decrease the time to display the content with the high audience rate.

Further, Patent Document 1 (JP 2001-268026) discloses a method of sorting the information to transmit into categories corresponding to the update frequency and emergency degree of the information, and setting timing to transmit for each category to transmit the information. It is thereby possible to preferentially transmit the information with the high update frequency and/or the high degree of emergency to recipients.

Among pieces of content, some are media data with high necessity to a recipient, while some are media data with low necessity to the recipient. For example, when reception and viewing of video content such as TV broadcast is carried out on a mobile terminal, a recipient of the content first needs to know what content is distributed in an area where the recipient is currently present. Accordingly, information with the highest necessity to viewers of content is summary information (for example, of a size with several hundreds of text characters and about a single sheet of static image, in which are described the plot and cast in a drama, or a host and guest in a variety program) indicative of the outline of a program, and it is necessary to promptly notify such information to recipients of content.

However, in the method of Patent Document 1, the transmission timing is determined based on the update frequency and/or emergency degree of information to transmit, but the necessity to users is not considered, and the application thereof is difficult to the example as described above.

Further, in the method of Non-Patent Document 2, the transmission cycles are decreased across all the data contained in the content with high audio rates. In other words, a short transmission cycle is also set on media data whose necessity is low to a view of the content.

Therefore, it is not possible to efficiently use the limited transmission band, and there arises a case where a short transmission cycle cannot be set on media data with high necessity composing another piece of content. Accordingly, in a reception terminal of content, the waiting time is increased for receiving data with the high necessity for frequent update, and the problem arises that the waiting time is increased for display or operation of the content.

As described above, the conventional methods have the problem of increases in the waiting time taken to display the content with high necessity in a reception terminal in limited transmission band.

### DISCLOSURE OF INVENTION

It is an object of the present invention to decrease the waiting time taken to display or operate content with high necessity in a reception terminal.

In the present invention, content is composed of a plurality of items of data, and a transmission cycle of media data and an information amount of the data to transmit are varied in transmitting the content, corresponding to the necessity of the media data composing the content.

According to the present invention, for example, a shorter transmission cycle can be set on media data with high necessity than on media data with low necessity, and it is thereby possible to set a shorter transmission cycle on information requiring faster viewing such as summary information than on the detailed information. As a result, when a reception terminal starts receiving content or conditions of a reception terminal change, it is possible to transmit media data so as to enable the terminal to faster update necessary data in the limited transmission band. Further, a larger information amount is set on media data with high necessity than on media data with low necessity, thereby enabling presentation of information corresponding to the necessity of a user in the limited transmission band, for example, such that a map of an area around the user is presented in detail, while a map of a remote area from the user is presented roughly.

### BRIEF DESCRIPTION OF DRAWINGS

FIG. 1A is a first configuration view showing a use mode of a communication network in a first embodiment of the present invention;

FIG. 1B is a second configuration view showing a use mode of a communication network in the first embodiment;

FIG. 1C is a third configuration view showing a use mode of a communication network in the first embodiment;

FIG. 2 is a view showing a use mode of a content distribution system according to the first embodiment;

FIG. 3 is a configuration diagram illustrating the content distribution system according to the first embodiment;

FIG. 4 is a view for illustrating a profile setting method according to the first embodiment;

FIG. 5 is a view showing described channel information according to the first embodiment;

FIG. 6 is a view showing a header of a transmission format according to the first embodiment;

FIG. 7 is a view showing an example where channel information is described in SDP according to the first embodiment;

FIG. 8 is a view showing an example where an operation rule is described in extended SQL description according to the first embodiment;

FIG. 9 is an operation flowchart of content distribution in a server according to the first embodiment;

FIG. 10 is an operation flowchart for a reception terminal to acquire channel information to display according to the first embodiment;

FIG. 11 is an operation flowchart when the reception terminal selects a channel according to the first embodiment;

FIG. 12 is a flowchart for the reception terminal to execute a program according to the first embodiment;

FIG. 13 is a view showing a use mode of a content distribution system according to a second embodiment of the present invention;

FIG. 14A is a view showing first data for a server to transmit according to the second embodiment;

FIG. 14B is a view showing second data for the server to transmit according to the second embodiment;

FIG. 14C is a view showing third data for the server to transmit according to the second embodiment;

FIG. 15 is a view showing channel information in distributing data according to the second embodiment;

FIG. 16 is a diagram illustrating a configuration of a content distribution system according to the second embodiment;

FIG. 17 is an operation flowchart for a reception terminal to acquire channel information to display according to the second embodiment;

FIG. 18 is an operation flowchart after a user of the reception terminal selects a program according to the second embodiment;

FIG. 19 is a flowchart for the reception terminal to interpret a program portion according to the second embodiment;

FIG. 20 is an operation flowchart for the reception terminal to monitor a registered event according to the second embodiment;

FIG. 21 is a view showing a use mode of a map distribution system according to a third embodiment of the present invention;

FIG. 22 is a view showing a use mode of a position-dependent game distribution system according to a fourth embodiment of the present invention; and

FIG. 23 is a configuration diagram of a reception terminal according to a fifth embodiment of the present invention.

### BESS MODE FOR CARRYING OUT THE INVENTION

### First Embodiment

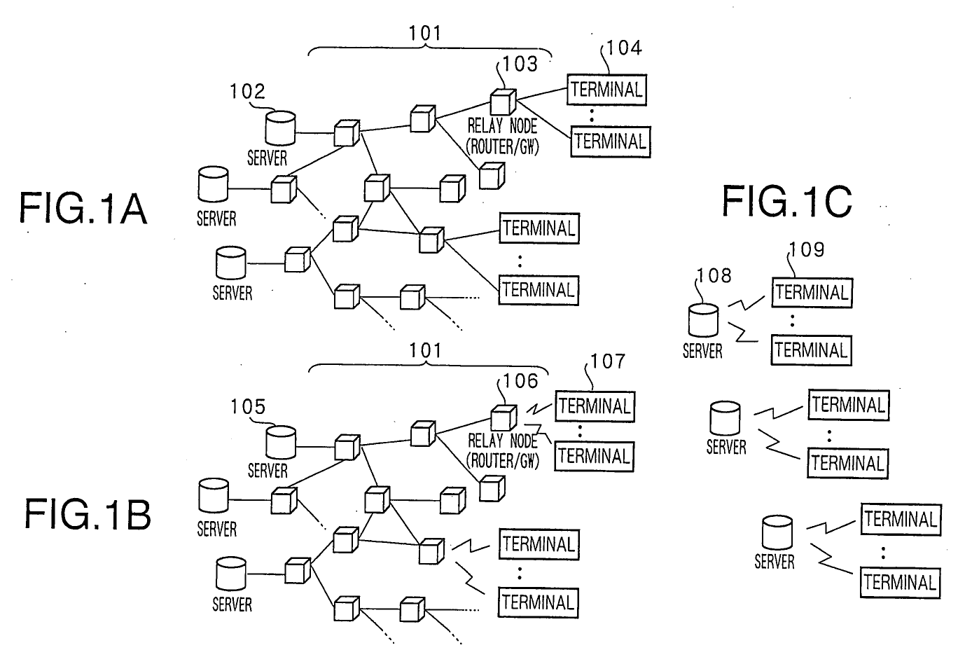

A content distribution system according to the first embodiment of the present invention will be described below with reference to accompanying drawings. First, a use mode of a communication network in the content distribution system according to the first embodiment will be described below with reference to FIGS. 1A to 1C. Each of FIGS. 1A to 1B is a configuration view showing the use made of the communication network in the first embodiment.

As shown in FIGS. 1A, in a media distribution system according to the first embodiment, server 102 that is a media data transmission apparatus transmits channel information and content, and reception terminal 104 that is a media data reception apparatus first receives the channel information, and based on the channel information, further receives the content.

In the first embodiment, the content to transmit includes a program, operation rule of the program, data for the program for use in the program as inputs such as a moving picture, speech, music, text and static image, and layout information for determining an arrangement of media.

The channel information includes information which is transmitted on a relevant channel and indicates a reception port to receive each media data composing content needed to receive the content. The channel information further includes a session title, start time and end time of the session, type of data transmitted as the content, destination channel, name of each media data to transmit, and a certificate of a public key associated with a secret key used in generating an electronic signature given to the media data or information to link the certificate.

Communication network 101 may be a cable network (such as, for example, ADSL, ISDN, ATM, FTTH) or a wireless network (such as, for example, a cellular telephone network, and wireless LAN). Further, as shown in FIG. 1B, communication network 101 may be a network where the cable networks and wireless networks are mutually connected.

Furthermore, as shown in FIG. 1C, a communication mode may be possible where servers 108 exist in respective locations and broadcast data to adjacent regions, and reception terminals 109 receive the data. In such a communication mode, Blue Tooth and/or wireless LAN is used as a transmission protocol.

In the first embodiment, an internet protocol is used as a transmission protocol, and communication apparatuses (servers 102 and reception terminals 104) are connected mutually via relay nodes 103 such as a router and GW (gateway). The router and GW are provided with the broadcast and/or multicast function, and are capable of replicating data packets.

As a method of transmitting content, server 102 and reception terminals 104 may perform one-to-one communications, or one-to-N communications using the broadcast or multicast function.

Reception terminals 104 include a cellular telephone, TV, PDA and personal computer. Further, as reception terminals 104, a plurality of reception terminals may exist at the same time which are different in display resolution and processing capability such as a cellular telephone, TV, PDA and personal computer.

Further, it may be possible that a plurality of servers 102 that distribute content exists and reception terminal 104 receives the content at the same time from the plurality of servers 102. Furthermore, reception terminal 104 may have the function of connecting to a plurality of transmission paths.

Moreover, a system may have a configuration with broadcast networks (such as, for example, terrestrial digital broadcast and satellite broadcast) or with incorporated broadcast and communication networks.

Further, when content is broadcast to moving reception terminals such as cellular telephones, there are demands for transmitting different content on an area basis. When a server transmits the content in broadcast or multicast to a plurality of reception terminals for such demands, it is not easy to change the content of broadcast corresponding to the position.

Therefore, in order to achieve broadcasting corresponding to the position, in the example in FIG. 1B, server 105 and relay node 106 communicate with each other in unicast of one to one (a cable-network region), and relay node 106 distributes the content to reception terminal 107 using the broadcast function using the wireless network. Relay node 106 that implements the broadcast function is not capable of broadcasting a packet via another relay node 106.

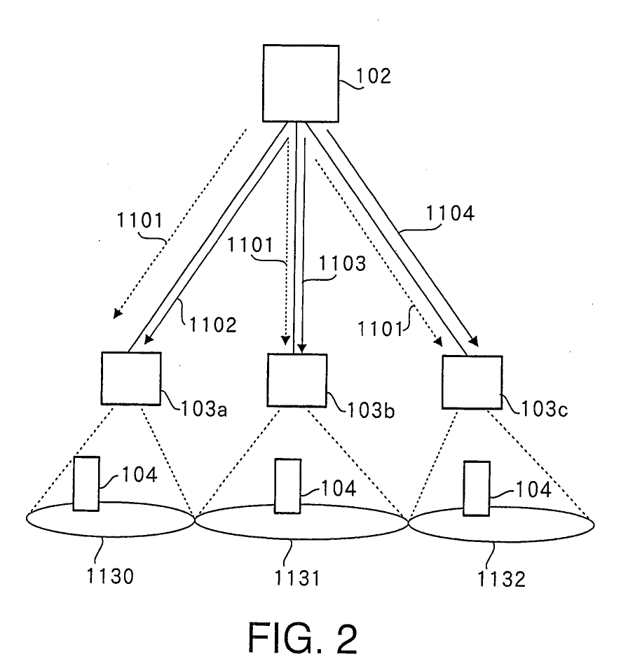

The outline of content distribution in the content distribution system according to the first embodiment will be described below with reference to FIG. 2. FIG. 2 is a view showing a use mode of the content distribution system according to the first embodiment.

In addition, while relay nodes 103 and reception terminals 104 are used in following descriptions, it may be possible to use relay nodes 106 and reception terminals 107 and 109.

Relay nodes 103a to 103c distribute data to distribution areas 1130 to 1132 respectively.

Server (transmission terminal) 102 that is a media data transmission apparatus transmits program 1101 and operation rule 1 (1102) to relay node 103a, program 1101 and operation rule 2 (1103) to relay node 103b, and program 1101 and operation rule 3 (1104) to relay node 103c.

Operation rules 1 to 3 (1102 to 1104) are different operation rules referred to by program 1101.

As channel information, relay nodes 103a to 103c transmit common data.

In performing such transmission, program 1101 that is common data can be used in distribution areas 1130 to 1132. For example, program 1101 received in distribution area 1130 can be used in distribution areas 1131 and 1132.

Accordingly, when reception terminal 104 moves from distribution area 1130 to distribution area 1131 or 1132, reception terminal 104 is capable of using program 1101 that is common data, and therefore, has little data to update.

Further, in consideration of the packet loss occurring on the transmission path, a smaller amount of data to update results in less time taken to completely receive all data. Therefore, distributing as in FIG. 2 reduces the reception waiting time.

Further, in the content distribution system, as the distribution area of media data is smaller, the transmission cycle of the media data is set to be short. In other words, in the example as shown in FIG. 2, the transmission cycle of program 1101 is set to be long, while the transmission cycles of operation rules 1102 to 1104 are set to be short. Assuming the case where reception terminal 104 receives the content while moving, program 1101 does not seem to vary to reception terminal 104, while operation rules 1102 to 1104 seem to vary to the reception terminal. Accordingly, by setting a shorter transmission cycle on media data as the distribution area of the media data is smaller, transmission frequencies of operation rules 1102 to 1104 that seem to have high update frequencies to the transmission terminal, the waiting time is made shorter which is taken to receive operation rules 1 to 3 (1102 to 1104) that the reception terminal needs to update frequently. In this way, the reception terminal is capable of keeping the content in the latest state.

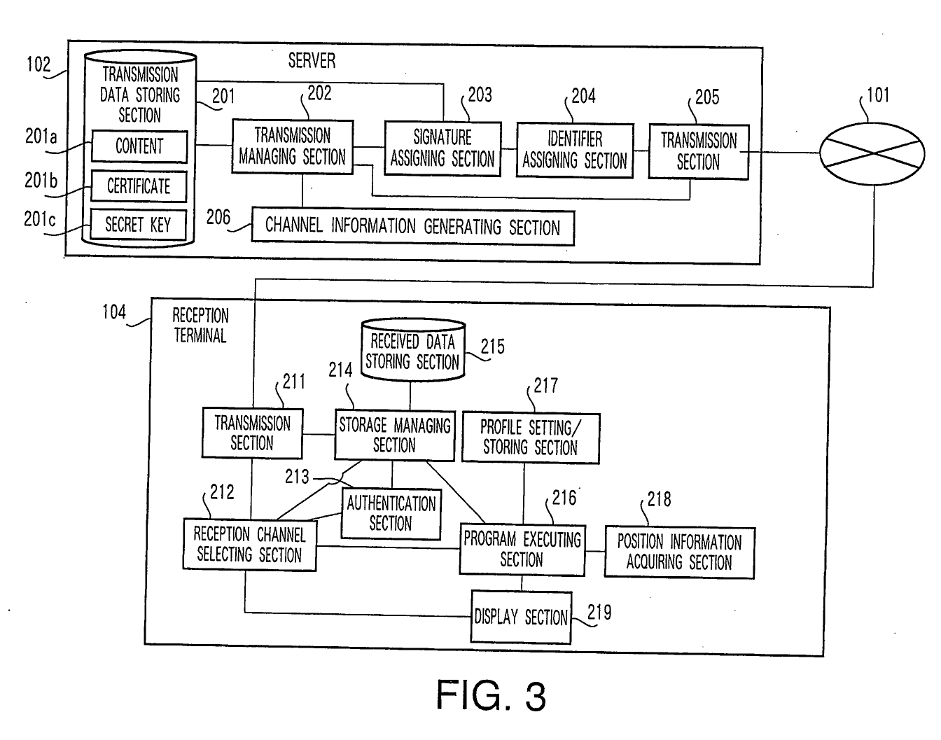

A configuration of the content distribution system according to the first embodiment will be described below with reference to FIG. 3. FIG. 3 is a diagram illustrating a configuration of the content distribution system according to the first embodiment.

In the system, reception terminal 104 first receives channel information on a predetermined channel, opens a channel for receiving the content described in the channel information, and receives the content.

The channel is indicated by a pair of a destination address and destination port number.

Server 102 (transmission terminal) that is a media data transmission apparatus is assumed to manage a plurality of pieces of content.

A configuration of server 102 will be described below.

Transmission data storing section 201 is means for storing content 201a, certificate 201b needed in reception terminal 104 in authenticating content 201a, and secret key 201c that corresponds to a public key contained in certificate 201b. More specifically, transmission data storing section 201 is a storage medium typified by a hard disk drive.

Content 201a is comprised of a program that is common data irrespective of areas, and the operation rule and data for the program that is different between the areas. The data for the program includes image data, text data, speech data and music data.

Certificate 201b is a public key certificate, and includes information with an electronic signature of an authentication station such as VeriSign (http://www.verisigh.co.jp/) where the information includes public key data (for use in decrypting the electronic signature), information of an owner of the public key, an effective period of the certificate, and information of the authentication station that issues the certificate. Thus, the validity of the owner of the public key is guaranteed by the authentication station.

Transmission managing section 202 is means for managing broadcast schedules of content. At the beforehand designated time of starting broadcasting each content, transmission managing section 202 acquires each media data composing content 201a separately from transmission data storing section 201, and divides each media data in a predetermined size to output to signature assigning section 203.

In the content distribution system according to this embodiment, content is transmitted repeatedly in a predetermined transmission cycle as in DSM-CC. Transmission managing section 202 determines the transmission cycle of content. The transmission cycle of media data is determined to be longer, as the distribution area of the media data is wider. For example, the transmission cycle is determined using the equation of (the transmission cycle constant)×(the number of distribution destination base stations). Herein, the transmission cycle constant is a value set by an administrator of the transmission apparatus, and is a transmission cycle when the number of distribution areas is 1. Further, the number of distribution areas represents the number of relay nodes, 103a, 103b, and 103c, which distribute the media data. In the example in FIG.2, the number of distribution areas of program 1101 is 3, while the number of distribution areas of operation rules (1102 to 1104) is 1. Accordingly, in the example, program 1101 is transmitted in a cycle three times that of operation rules 1102 to 1104.

At the end time, transmission managing section 202 finishes transmission of the content. The section 202 has the function of transmitting, at the content transmission start time, information (title of the content, transmission start time and end time, and type and name of each media data to transmit as the content) of the content whose transmission is started to channel information generating section 206, while notifying, at the content transmission end time, the end of the transmission of the content to transmission section 205.

In addition, it may be possible to designate the transmission start time and transmission end time of content, file name of data to transmit as the content, distribution area of each media data composing the content, and the transmission cycle constant, using a setting file or using GUI.

Signature assigning section 203 is means for generating an electronic signature to assign to media data provided from transmission managing section 202. Signature assigning section 203 acquires secret key 201c for use in generating the electronic signature from transmission data storing section 201. In addition, the electronic signature may be generated and prepared in advance by a content creator, instead of being generated in signature assigning section 203.

The electronic signature is to indicate that the content is created and distributed by a proper distributor and is not tampered while being transmitted. More specifically, a hash value is generated from content data using the hash function (for example, MD5 and SHA), and is encrypted using the secret key that the content distributor has. Further, as a scheme of electronic signature, it is assumed to use schemes such as MD5 and SHA. Distributing the certificate and electronic signature prevents reception terminals from starting up improper content and thereby performing improper operation.

Identifier assigning section 204 assigns identifiers indicative of correspondence (of which program and which data the program refers to) to programs, operation rules and data for the program of content 201a output from signature assigning section 203.

As the identifier, identifier assigning section 204 assigns the same number to corresponding program, operation rule and data for the program. In other words, identifier assigning section 204 assigns different numbers for each piece of content.

In this way, reception terminal 104 is capable of recognizing that the program, operation rule and data for the program assigned the same number have the correspondence.

Identifier assigning section 204 has the function of outputting the data assigned the identifier to transmission section 205.

Channel information generating section 206 is means for generating channel information of each content 201a based on the information notified from transmission managing section 202 and certificate 201b stored in transmission data storing section 201.

The channel information includes a tile of a session, start time and end time of the session, type of data transmitted as the content, destination channel, name of each media data to transmit, and a certificate of a public key corresponding to the secret key used in generating the electronic signature assigned to the media data or link information to the certificate.

As a protocol for channel information description, it is assumed to use a protocol for session description, typified by SDP. Specific examples of channel information will be described later.

The channel information is also assumed to be transmitted repeatedly on a regular basis.

In this way, server 102 notifies a destination channel as well as media data to reception terminal 104 using the channel information. Therefore, even when server 102 transmits media data to reception terminal 104 on an arbitrary channel, reception terminal 104 is capable of receiving the media data using the destination channel of the channel information.

Further, the channel information includes the session title, session start time and end time, type of data transmitted as the content, and name of each media data to transmit. Therefore, by transmitting the channel information from server 120 to reception terminal 104, even when server 102 transmits media data included in the content on an arbitrary channel, reception terminal 104 is capable of associating the media data included in the content, and receiving the operation rule and data for the program to which the program included in the content responds properly.

Transmission section 205 has the interface function of connecting to network 101, and further has the function of packetizing data received from identifier assigning section 204 to transmit to network 101. Further, transmission section 205 transmits data in a transmission cycle set by transmission managing section 202.

Server 102 is configured as described above.

A configuration of reception terminal 104 will be described below.

Transmission section 211 receives the channel information and content 201a from network 101 to depacketize. When the received data is the channel information, the section 211 transmits the data to reception channel selecting section 212. When the received data is content 201a, the section 211 transmits the data to storage managing section 214.

Transmission section 211 has the function of opening a reception channel of content 201a by an instruction from reception channel selecting section 212. Further, transmission section 211 is means for acquiring the data based on URL from a server indicated by the URL, when the channel designated from reception channel selecting section 212 is URL.

Reception channel selecting section 212 is means for selecting content 201a to receive from a plurality of pieces of channel information notified from transmission section 211. As a method of selecting a channel in reception channel selecting section 212, there may be a method of presenting titles of content 201a to a user among the channel information to cause the user to select content 201a, or a method of automatically receiving content 201a of first received channel information.

Further, based on the channel information described in the channel information, reception channel selecting section 212 notifies transmission section 211 of a channel to open, in selecting content 201a. When receiving URL from program executing section 216, reception channel selecting section 212 acquires data based on URL from the server.

Reception channel selecting section 212 further has the function of transmitting certificate 201b of the selected channel to authentication section 213 when the channel information includes certificate 201b for content authentication.

When receiving a notification indicative of completion of reception of a program, operation rule and data for the program from storage managing section 214, reception channel selecting section 212 is set for halting the data reception, and therefore, has the function of closing the reception channel for the program, operation rule and data for the program to finish the reception.

Storage managing section 214 stores the received media data in received data storing section 215. When storing received media data, storage managing section 214 associates the program, operation rule, data for the program with one anther to store, based on the identifier assigned to the media data.

Herein, storing in such association is storing so as to make it clear that a program, operation rule and data for the program each assigned the same identifier compose the same content. For example, storage managing section 214 stores the program, operation rule and data for the program in a directory with the same name as that of the identifier. Further, storage managing section 214 uses the name of each media data described in the channel information as a file name of the media data in storing the data.

When the media data is assigned the electronic signature data, storage managing section 214 also associates the electronic signature data with the media data to store.

Herein, storing the electronic signature data and media data in association with each other is storing so as to make it clear that which media data corresponds to the electronic signature data. For example, the electronic signature may be stored in the same directory as that of the media data, with a name of “(name of media data)_Sign”.

When receiving all the divided media data, storage managing section 214 combines the divided media data. Further, storage managing section 214 has the function of transmitting the electronic signature assigned to the media data and the media data to authentication section 213, and further transmitting the media data to program executing section 213 when receiving an authentication success notification from authentication section 213.

When completing the reception of the program and operation rule, storage managing section 214 transmits a reception completion notification to reception channel selecting section 212.

Authentication section 213 receives certificate data from reception channel selecting section 212, further receives an electronic signature corresponding to the media data from storage managing section 214, authenticates that content 201a is certainly created (or transmitted from) by the organization that issues certificate 201b, and notifies storage managing section 214 of the authentication result.

Program executing section 216 receives the program notified from storage managing section 214 to execute. At this point, when the program instructs to refer to an operation rule, program executing section 216 requests storage managing section 214 to transmit the reference program.

When the program intends to access the content indicated by URL, program executing section 216 refers to a security profile (permission of connection to the network) stored in profile setting/storing section 217. Then, when the access to the URL does not violate the security profile, program executing section 216 transmits the URL to reception channel selecting section 212 to instruct to acquire data of the URL.

When it is described accessing a user profile, program executing section 216 first refers to the security profile (permission of access to the user profile). When the access to the user profile does not violate the security profile, program executing section 216 refers to the user profile stored in profile setting/storing section 217.

When it is described acquiring a present position of the reception terminal, program executing section 216 refers to the security profile (permission of access to position information). When the access to the position information does not violate the security profile, program executing section 216 acquires the information of the present position from position information acquiring section 218.

Display section 219 is means for presenting a processing result of the program to a user. More specifically, the section 219 includes video displaying means such as CRT and LCD, audio output means such as a speaker, and a vibrator provided in a cellular telephone. Further, when a user selects the content, display section 219 is used by reception channel selecting section 212 to display the channel information.

Profile setting/storing section 214 is means for setting and storing various profiles such as terminal profiles, user profiles and security profiles.

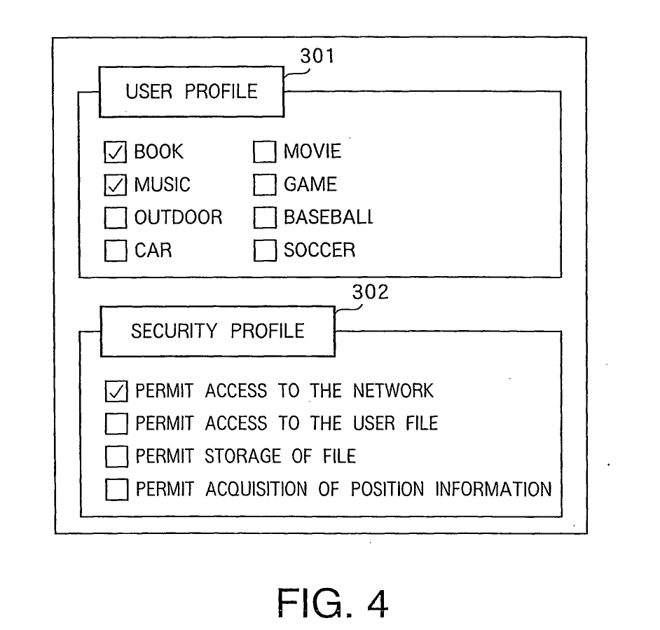

Setting of user profile and security profile is performed, for example, using GUI as shown in FIG. 4. FIG. 4 is a view for illustrating a profile setting method according to the first embodiment.

GUI as shown in FIG. 4 displays items indicative of subjects of user's interest such as book, music, outdoor, car, movie, game, baseball, and soccer, as user profile 301.

A user places a checkmark in the checkbox of item in user profile 310, and thereby sets user profile 301.

GUI as shown in FIG. 4 displays items indicative of permission of access to network, file, user profile or position information, as security profile 302.

A user places a checkmark in the checkbox of item to permit access to the resource (network, file, user profile or position information) in executing the program, and thereby sets security profile 302.

Position information acquiring section 218 is means for acquiring a present position of reception terminal 104. More specifically, the section 218 is position specifying means using GPS, base station information of cellular telephone or wireless LAN, RF-ID tag, radio signal issued from a wireless beacon, etc. Position information acquiring section 218 has the function of transmitting acquired position information to program executing section 216. Examples used as the position information are information of the latitude and longitude, GPS data, number of a base station of a related area, address/place name, postal code, and telephone number.

Reception terminal 104 is configured as described above.

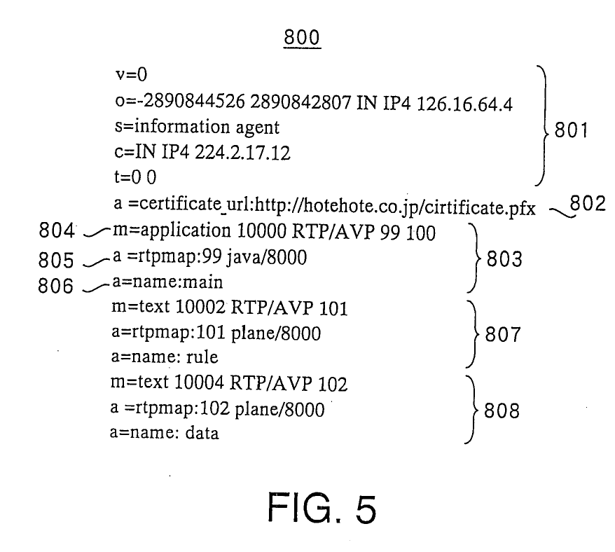

Referring to FIG. 5, the channel information will be described below when server 102 transmits a program, operation rule and data for the program as the content. FIG. 5 is a view showing described channel information according to the first embodiment.

Channel information 800 as shown in FIG. 5 is described using SDP.

A portion denoted by “801” in channel information 800 conforms to specifications of SDP. Accordingly, it is indicated that program data is transmitted to an IP address described in a field of “c=”.

A portion denoted by “802” in channel information 800 indicates URL of certificate data, and thereby indicates that using the URL allows the content to be authenticated. In this example a certificate is acquired using URL, but the certificate data itself may be added to portion 802, instead of the URL.

A portion denoted by “803” in channel information has data indicative of information on distribution of the program.

A portion denoted by “804” in channel information 800 indicates transmitting data to port number 10,000 using RTP/UDP/IP protocol by setting 100 on the payload type of RTP.

A portion denoted by “805” in channel information 800 indicates that a packet with the RTP payload type of 100 is a Java® program and that a clock rate of time stamp of RTP is 8,000.

A portion denoted by “806” in channel information 800 indicates that a name of the application is “main”. “main” is a name having specific meaning, and there is a rule that data assigned the name of “main” is executed first as a program.

A portion denoted by “807” in channel information 800 indicates information on distribution of text (operation rule of the program), and has the format equal to the portion denoted by “803”. The program knows the name of the operation rule (in this example, “rule”), and based on the name, is capable of accessing the operation rule.

A portion denoted by “808” in channel information 800 indicates information on distribution of text (data for the program). The program knows the name of the data for the program (in this example, “data”), and based on the name, is capable of accessing the data for the program.

As described above, channel information 800 has a structure including information, such as a destination port number that is a channel and payload type, required for receiving the content.

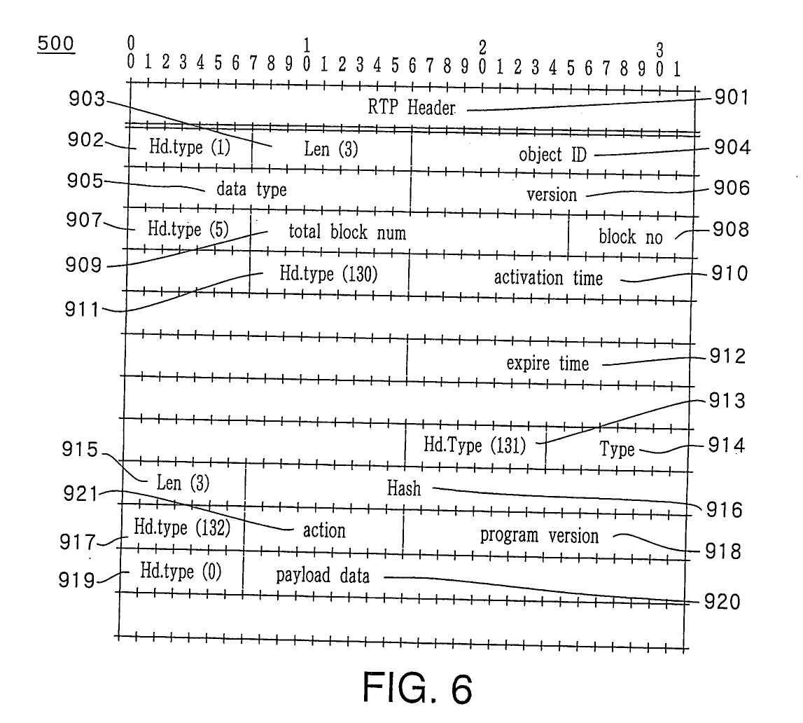

A transmission format to transmit the program, operation rule and data for the program will be described below with reference to FIG. 6. FIG. 6 is a view showing a header of the transmission format according to the first embodiment.

Header 500 as shown in FIG. 6 is described as a payload header of RTP.

The payload format is formed to first distinguish between types of headers using a header type (Hd.Type) and then store information of each header type. With respect to each header type, a header length is specified in advance on the header with the fixed length, while a header length is input in a rearward position in the header with the length that is not fixed.

A portion denoted by “901” in header 500 is a general RTP header portion.

A portion denoted by “902” in header 500 is a field indicating an ID information header. In the example in FIG. 6, a value of “1” represents the ID header information.

A portion denoted by “903” in header 500 indicates a length of ID information in byte. In the example in FIG. 6, the ID information has 3 bytes, and the value is “3”.

A portion denoted by “904” in header 500 is ID uniquely indicating the content, and a common value is input among the program, operation rule, and data for the program in a single piece of content.

A portion denoted by “905” in header 500 is a field indicative of a type of data, and has a beforehand specified value for each type of data such that, for example, “1”, “2” and “3” are respectively input for the program, operation rule and data for the program.

A portion denoted by “906” in header 500 is a version field, and is incremented by 1 whenever each media data is updated.

A portion denoted by “907” in header 500 is a field indicating a number-of-packet header. In the example in FIG. 6, “5” represents the number-of-packet header.

A portion denoted by “909” in header 500 indicates the number of packets composing the media data.

A portion denoted by “908” in header 500 indicates a position of the packet starting with the beginning as a first one among a plurality of packets composing the media data. Using information 908, missing information due to congestion of media data packet and packet loss is complemented by periodical transmission.

A portion denoted by “911” in header 500 indicates an activation time/expire time header. In the example in FIG. 6, “130” represents the activation time/expire time header.

A portion denoted by “910” in header 500 is an activation time field. A portion denoted by “912” is an expire time field. Activation time field 910 indicates when the media data is activated, while expire time field 912 indicates when the media data is expired, in NTP (Network Time Protocol) time.

When the media data is activated is the time a program is executed if the data is the program, while being the time media data is provided to the program if the data is not the program. The case without this field is assumed that the media data is activated concurrently with completion of the reception of the data, and is not expired.

A portion denoted by “913” in header 500 indicates an electronic signature header. In the example in FIG. 6, “131” represents the electronic signature header.

A portion denoted by “914” in header 500 is a field representing a type of the electronic signature (such as MD5 and SHA). A portion denoted by “915” in header 500 is a field to which a length of the electronic signature data is input.

A portion denoted by “916” in header 500 is a portion to which the electronic signature date is input. Data 916 is used by a reception terminal in authenticating the media data. The information of electronic signature may be stored in a payload, instead of a payload header. In this case, there is a method of distinguish between media data and electronic signature data using a payload type of RTP.

It may be possible to beforehand select a specific packet such as a packet with a maximum sequence number or minimum sequence number among a series of packets and use a payload of the packet as the information of electronic signature.

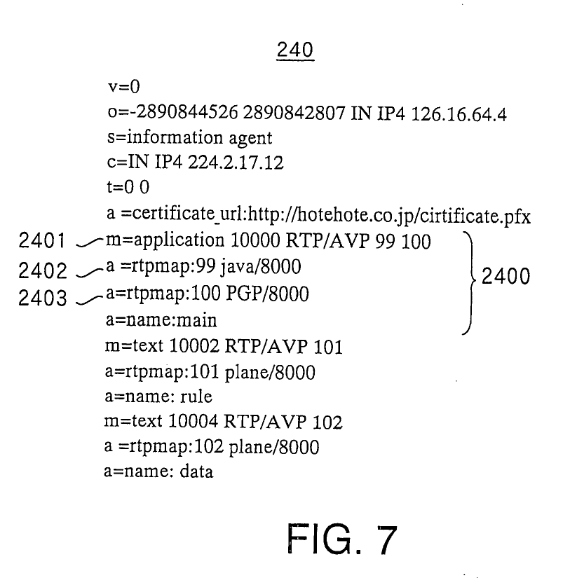

Further, as a method of determining whether data of a payload of RTP is media data or electronic data, there is a method of describing such information in the channel information. The method will be described below with reference to FIG. 7.

A portion denoted by “2400” in channel information 240 as illustrated in FIG. 7 is data indicative of information on distribution of the program.

A portion denoted by “2401” in channel information 240 indicates transmitting data to port number 10,000 that is a channel using RTP/UDP/IP protocol by setting 99 and 100 on the payload types of RTP.

A portion denoted by “2401” in channel information 240 indicates that a packet with the RTP payload type of 99 is a Java® program and that a clock rate of time stamp of RTP is 8,000.

A portion denoted by “2403” in channel information 240 indicates that a packet with the RTP payload type of 100 is an electronic signature and that a clock rate of stamp of RTP is 8,000.

A portion denoted by “2401” in channel information 240 is information on a channel on which the program and electronic signature are transmitted.

Also in this way, it is possible to determine whether data of a payload of RTP is media data or electronic signature data.

When the electronic signature is stored in a payload itself, fields denoted by “913” to “916” are eliminated among fields in RTP payload header 500.

A portion denoted by “917” in header 500 indicates an operation rule header. In the example in FIG. 6, “132” represents the operation rule header.

A portion denoted by “921” in header 500 is a field which represents an action and indicates whether to add or update the operation rule previously transmitted.

A portion denoted by “918” in header 500 is a field indicating a version of the program, and indicates a version of program to which the operation rule is applicable. The value of field 918 is compared with the value of field 906 in receiving the program that the reception terminal keeps, and when the value of field 906 (i.e., the version of the program that the reception terminal keeps) is more than the value of field 918, it is possible to apply the operation rule transmitted in this packet.

A portion denoted by “919” in header 500 indicates an operation rule header. In the example in FIG. 6, “0” represents the operation rule header. A portion denoted by “920” in header 500 indicates payload data.

Using header 500 as described above, the program, operation rule and data for the program are transmitted.

Since the above-mentioned fields are headers having values common to media data except the number-of-packet field, these headers do not need to be assigned to all the packets, and need to be assigned to at least one data packet among the data packets composing the media data.

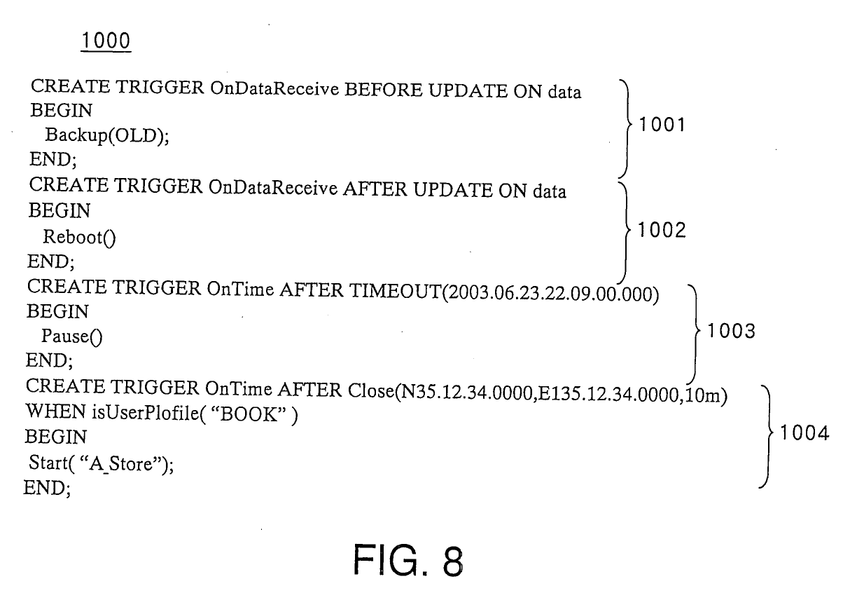

The operation rule according the first embodiment will be described below with reference to FIG. 8. FIG. 8 is a view showing an example where an operation rule is described in extended SQL description according to the first embodiment.

A portion denoted by “1001” in operation rule 1000 specifies calling the function of “Backup ( )” using “OLD” as an argument when data with a name of data (the name is described in the channel information) is updated.

“Backup ( )” is assumed to be the function installed in the program, and to describe the operation of storing data provided as the argument as backup. Further, “OLD” indicates last data before being updated. Accordingly, the entire portion denoted by “1001” indicates backing up the last data in receiving the data.

A portion denoted by “1002” in operation rule 1000 indicates rebooting the program in receiving new data.

A portion denoted by “1003” in operation rule 1000 indicates temporarily halting the program at 10 p.m., 09′, 00″000, Jun. 23, 2003.

A portion denoted by “1004” in operation rule 1000 indicates calling the function of Start ( ) when the user is interested in books as a user profile and approaches within 10 meters from a position of latitude 35^{▪} 12′34.0000″00 north and longitude 135^{▪}12′34.0000″ east.

“Start” is the function to start receiving the data, and it is indicated to start receiving data for the program with a name of “A_store”.

Operation rule 1000 is configured as described above.

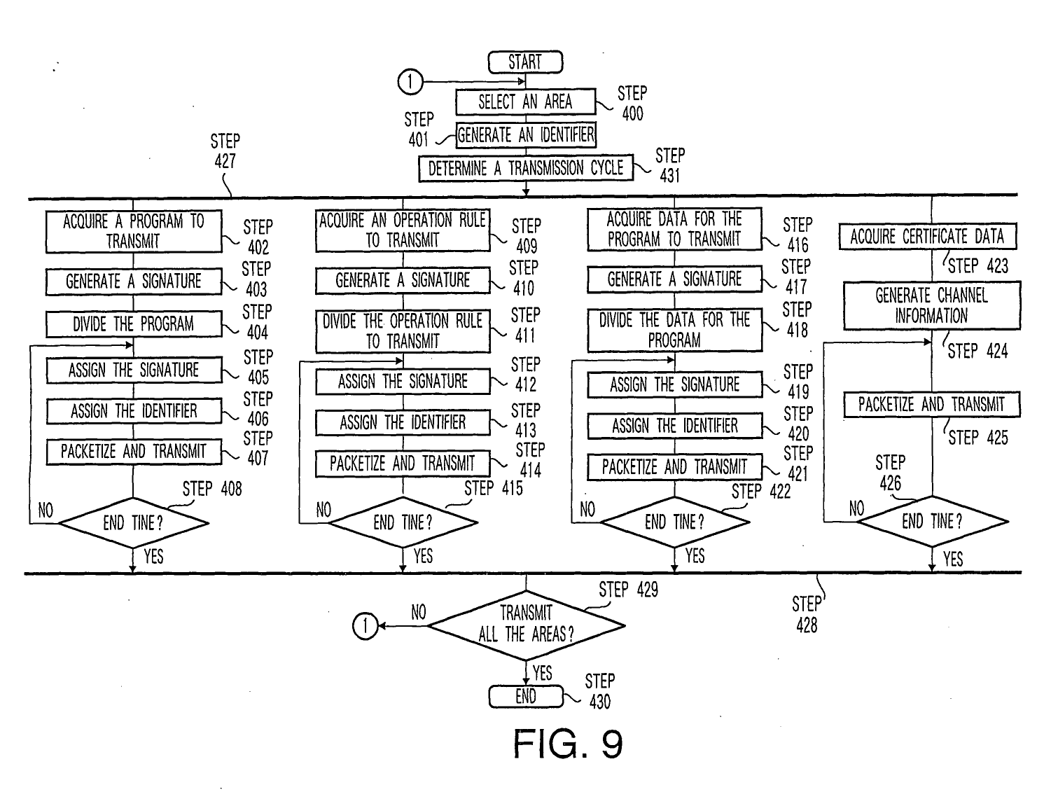

The content distribution operation in server 102 will be described below with reference FIG. 9.

FIG. 9 is a flowchart of the content distribution operation in server 102 according to the first embodiment.

Server 102 starts up the content distribution operation when it is the time of content transmission.

First, transmission managing section 202 in server 102 selects an area to transmit the content (step 400).

Next, transmission managing section 202 in server 102 generates an identifier that does not overlap the other content (step 401).

Then, transmission managing section 202 in server 102 determines a transmission cycle of media data contained in the content (step 431).

The transmission cycle of media data is determined to be longer as a distribution area of the media data is wider.

For example, the cycle is determined using an equation of “transmission cycle constant”×“the number of distribution destination base stations”). The transmission cycle constant is a value set by an administrator of the transmission apparatus, and is a transmission cycle when the number of distribution areas is 1. Further, the number of distribution areas represents the number of relay apparatuses, 103a, 103b, and 103c, which distribute the media data. In the example in FIG. 2, the number of distribution areas of program 1101 is 3, while the number of distribution areas of operation rules (1102 to 1104) is 1. Accordingly, in the example, program 1101 is transmitted in a cycle three times that of operation rules 1102 to 1104.

In this way, the transmission cycle of media data is determined to be longer as a distribution area of the media data is wider. The media data distributed in a wide area has a high possibility of being received by a lot people already, while the media data distributed in a narrow area has a high possibility of being not received by almost users. Accordingly, decreasing the transmission cycle of data with a narrow distribution area decreases the transmission cycle of data that is not received, and therefore decreases the reception waiting time, whereby it is possible to receive data needed on the receiving side promptly.

Transmission managing section 202 refers to transmission data storing section 201, and starts processing for transmitting the program, operation rule and data for the program composing the content to transmit to an area selected in step 400, and channel information separately (step 427).

In step 427, each processing indicated by a line vertically drawn from the line of step 427 is carried out in parallel.

As the program transmission processing, transmission managing section 202 first acquires a program to transmit to the distribution area determined in step 400, from transmission data storing section 201 (step 402). In addition, since the program is common data to transmit to all the areas, the program acquired in transmission managing section 202 herein is the same as a program acquired in the processing to another area.

Signature assigning section 203 in server 102 generates electronic signature data of the program acquired in step 402 (step 403).

Transmission managing section 202 in the server divides the program acquired in step 402 (step 404). Then, signature assigning section 203 assigns the electronic signature generated in step 403 to each divided data (step 405).

In addition, in this embodiment the electronic signature is assigned to all the data, but it may be possible to assign the electronic signature to only representative data to transmit. Further, it may be possible to transmit a packet with only data of electronic signature. The foregoing is the same as in the rule and data for the program as described below.

By thus assigning an electronic signature to a program, reception terminal 104 is capable of authenticating the program using the certificate assigned to the channel information, and is prevented from starting up an improper program and thereby performing improper operation.

Signature assigning section 203 assigns an identifier generated in step 401 to the data assigned the electronic signature in step 405 (step 406). Transmission section 205 adds a required packet header to the data assigned the identifier in step 406 to transmit in the transmission cycle set by transmission managing section 202 (step 407).

Then, when the end time does not expire (step 408), server 102 returns to the processing of step 405. Server 102 repeats the processing of steps 405 to 408 until the end time, and finishes the processing at the end time.

The processing for transmitting an operation rule in server 102 will be described below.

As the processing for transmitting an operation rule, transmission managing section 202 first acquires an operation rule corresponding to the area selected in step 400, from transmission data storing section 201 (step 409). In addition, since the operation rule is data different for each area, the operation rule acquired in transmission managing section 202 herein is different from an operation rule acquired in the processing to another area.

Signature assigning section 203 in server 102 generates electronic signature data of the operation rule acquired in step 409 (step 410).

Transmission managing section 202 in the server divides the operation rule acquired in step 409 (step 411). Then, signature assigning section 203 assigns the electronic signature generated in step 410 to each divided data (step 412).

By thus assigning an electronic signature to an operation rule, reception terminal 104 is capable of authenticating the operation rule using the certificate assigned to the channel information, and is prevented from using an improper operation rule and thereby performing improper operation.

Signature assigning section 203 assigns an identifier generated in step 401 to the data assigned the electronic signature in step 412 (step 413). Transmission section 205 adds a required packet header to the data assigned the identifier in step 413 to transmit in the transmission cycle set by transmission managing section 202 (step 414).

Further, in step 414, transmission section 205 is capable of setting a shorter transmission cycle of the operation rule than the transmission cycle of the program. In this way, reception terminal 104 is capable of promptly receiving the operation rule requiring the update with movement of the reception terminal 104, i.e., requiring frequent update, and reducing the update waiting time.

Then, when the end time does not expire (step 415), server 102 returns to the processing of step 412. Server 102 repeats the processing of steps 412 to 415 until the end time, and finishes the processing at the end time.

The processing for transmitting data for the program in server 102 will be described below.

As the processing for transmitting data for the program, transmission managing section 202 first acquires data for the program corresponding to the area selected in step 400, from transmission data storing section 201 (step 416). In addition, since the data for the program is data different for each area, the data for the program acquired in transmission managing section 202 herein is different from data for the program acquired in the processing to another area.

Signature assigning section 203 in server 102 generates electronic signature data of the data for the program acquired in step 416 (step 417).

Transmission managing section 202 in the server divides the data for the program acquired in step 416 (step 418). Then, signature assigning section 203 assigns the electronic signature generated in step 417 to each divided data (step 419).

By thus assigning an electronic signature to data for the program, reception terminal 104 is capable of authenticating the data for the program using the certificate assigned to the channel information, and is prevented from using improper data for the program and thereby performing improper operation.

Signature assigning section 203 assigns an identifier generated in step 401 to the data assigned the electronic signature in step 419 (step 420). Transmission section 205 adds a required packet header to the data assigned the identifier in step 420 to transmit (step 421).

Further, in step 421, transmission section 205 is capable of setting a shorter transmission of the data for the program than the transmission cycle of the program. In this way, reception terminal 104 is capable of promptly receiving the data for the program requiring the update with movement of the reception terminal 104, i.e., requiring frequent update, and reducing the update waiting time.

Then, when the end time does not expire (step 422), server 102 returns to the processing of step 419. Server 102 repeats the processing of steps 419 to 422 until the end time, and finishes the processing at the end time.

The processing for transmitting channel information in server 102 will be described below.

Server 102 acquires certificate data to authenticate the electronic signature from transmission data storing section 201 (step 423).

Next, server 102 acquires data necessary to generate the channel information, and adds the certificate data acquired in step 423 to generate the channel information (step 424). Then, server 102 packetizes the channel information to transmit in transmission section 205 (step 425).

By thus assigning a certificate to the channel information, reception terminal 104 is capable of recognizing the validity of the media data using the electronic signature assigned to each media data, and is prevented from starting up improper content and thereby performing improper operation.

When the end time does not expire (step 426), server 102 returns to the processing of step 425. Server 102 repeats the processing of step 425 until the end time, and then, finishes the processing.

Server 102 thus transmits the program, operation rule, data for the program and channel information. In this way, based on the channel information, reception terminal 104 is capable of receiving the program, operation rule, and data for the program.

Further, since server 102 assigns a common identifier to the program, operation rule, data for the program and channel information, reception terminal 104 is capable of associating the program, operation rule, data for the program, and channel information with one another. Since the identifier is different for each content, even when reception terminal 104 receives a plurality of pieces of content at the same time, the terminal 104 is capable of receiving the content to use without confusing between pieces of content.

In addition, step 428 represents that server 102 shifts to the processing described below step 428 when processing for inputting in step 428 is all completed.

Thus, server 102 transmits a program common to all the areas, operation rule and data for the program different for each area, and channel information (steps 429 and 430).

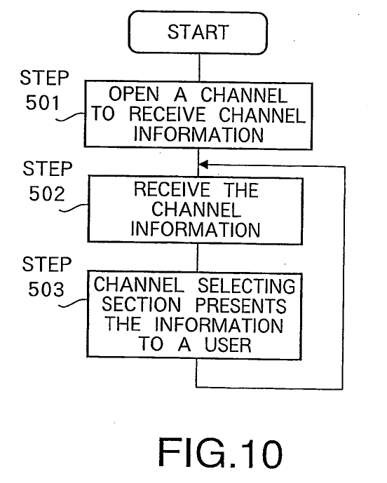

Content reception processing in reception terminal 104 will be described below. Referring to FIG. 10, first described is the operation for acquiring channel information to display in a selection method where reception terminal 104 causes a user to select a channel. FIG. 10 is an operation flowchart for reception terminal 104 to acquire channel information to display according to the first embodiment.

First, reception channel selecting section 212 in reception terminal 104 opens a channel to receive the channel information (step 501). It is assumed that the channel is beforehand specified, and that the channel information can be received on the channel always.

Reception channel selecting section 212 waits for receiving the channel information, receives the transmitted channel information (step 502), and extracts the title information from the channel information to present to a user (step 503).

Reception channel selecting section 212 returns to the processing of step 502, and waits for receiving next channel information.

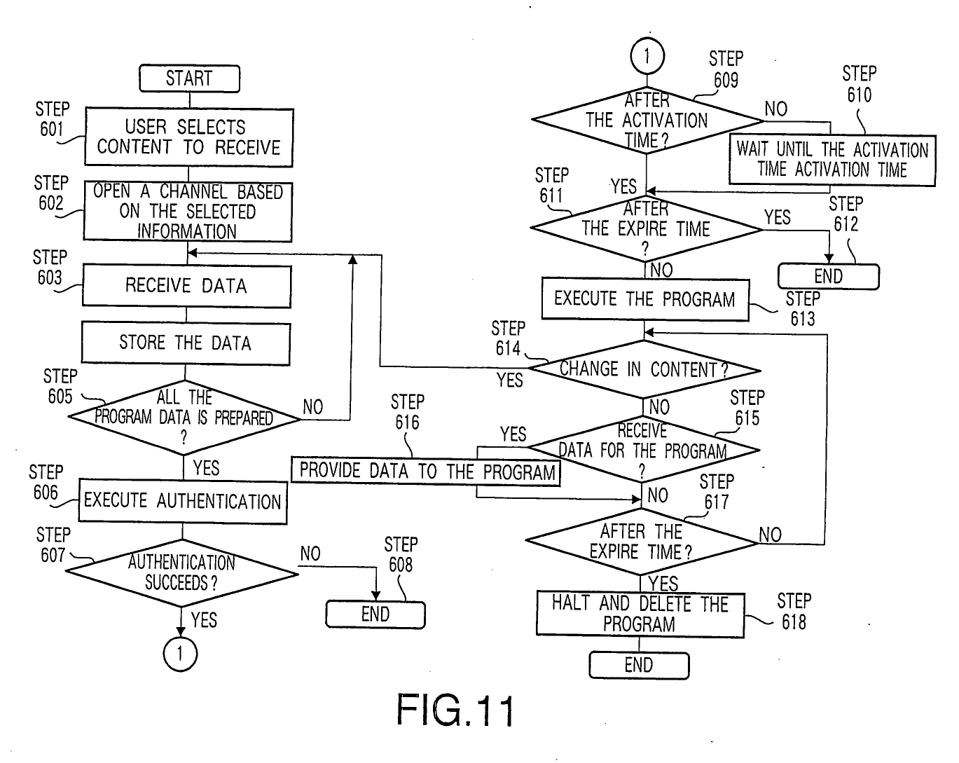

The operation when reception terminal 104 selects a channel to receive will be described with reference to FIG. 11. FIG. 11 is an operation flowchart when reception terminal 104 selects a channel according to the first embodiment.

When a user selects content displayed on display section 219 (step 601), reception channel selecting section 212 acquires a reception channel of each media from the channel information of the selected content, and opens the reception channel of each media (step 602).

Then, in reception terminal 104, transmission section 211 receives the content data (program, operation rule and data for the program) from the opened channels (step 603), and storage managing section 214 stores the received content in reception data storing section 215 (step 604).

Storage managing section 214 determines whether all the data has been received (step 605). When all the data has been received, transmission section 211 halts the operation for receiving the content.

In this way, reception terminal 104 is prevented from receiving the same data as that already received successively, and is capable of reducing power to receive the content.

Meanwhile, when all the content data has been received (step 605), authentication section 213 authenticates the program (step 606).

By thus authenticating the program, reception terminal 104 is capable of recognizing the validity of the program, and is prevented from starting up an improper program and thereby performing improper operation.

When authentication section 213 fails to authenticate (step 607), program executing section 216 finishes the processing without executing the program (step 608).

Meanwhile, when the authentication result indicates success, program executing section 216 checks whether the activation time of the program has gone (step 609).

When the activation time has not gone, program executing section 216 halts the processing until the activation time (step 610).

When the activation time has gone, program executing section 216 checks whether the expire time has gone (step 611).

Program executing section 216 finishes the processing when the expire time has gone (step 612), while executing the program when the expire time has not gone (step 613).

Since the received content has a possibility of being updated including the program, program executing section 216 monitors update of media data (step 614), and when the media data is changed, returns to the processing of step 603.

When the media data changes, program executing section 216 only receives the media data that has changed, in step 603.

By thus updating only the media data requiring update, it is possible to increase the speed of the content reception operation.

After halting the operation for receiving the changed media data, reception terminal 104 notifies the user of halt of the reception operation.

The user is thus capable of recognizing the updated latest media, and performing reproduction of the program using the updated media, instead of media data currently used.

In addition, as a method of detecting update of media data in program executing section 216, a method is assumed of assigning an identifier that uniquely determines the media data to a header portion of a data packet, and based on a change in the identifier, detecting update.

Further, since the operation rule and data for the program is data different for each area, it may be possible that the operation data and data for the program is updated when position information acquiring section 218 detects a change in the area where reception terminal 104 exists.

When transmission section 211 receives the data for the program (step 615), storage managing section 214 provides the data to program executing section 216 (step 616).

When the expire time of the program has gone (step 617), program executing section 216 halts the program, and when necessary, deletes the program (step 618).

In addition, in the operation as described above, when the program cannot be executed due to failure of authentication or lapse of the expire time, it may be possible to notify the user of failure of execution of the program when necessary.

Reception terminal 104 thus executes the program. Further, when the media data is updated, reception terminal 104 updates the data and executes the program.

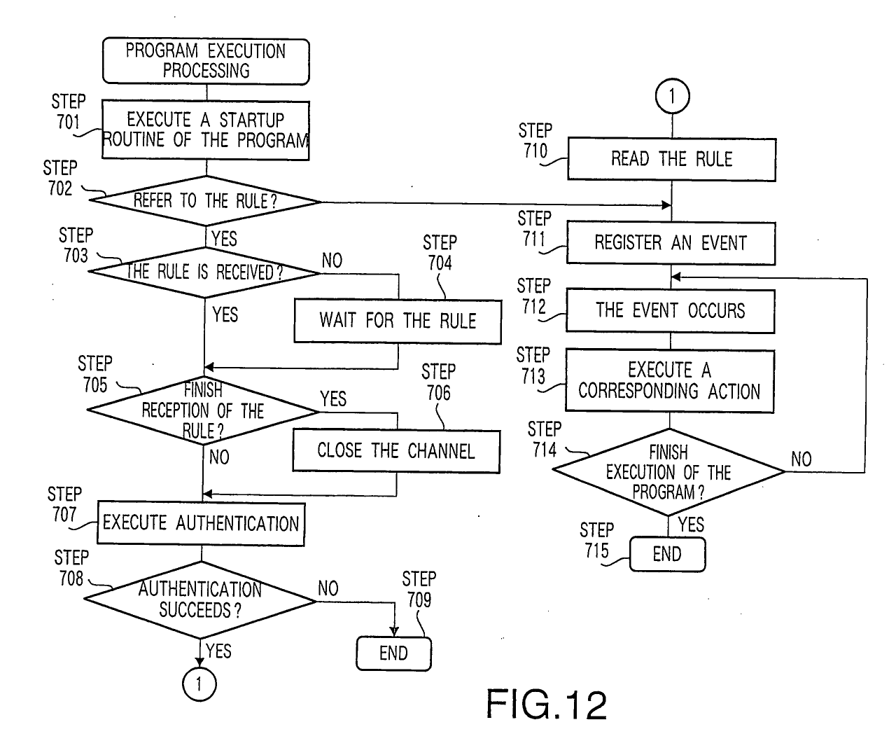

The processing (that is started in step 613) for executing a program in reception terminal 104 will be described below with reference to FIG. 12. FIG. 12 is a flowchart for reception terminal 104 to execute a program according to the first embodiment.

First, program executing section 216 executes startup of the program provided as an argument (step 701). Next, program executing section 216 determines whether a rule needs to be referred to (step 702), and when the rule needs to be referred to, checks whether the operation rule to be referred to is stored (step 703).

When the rule is not stored, program executing section 216 waits for receiving the operation rule (step 704)

After completing reception of the rule, when the setting of reception operation completion is ON (step 705), program executing section 216 closes the reception channel, finishes the reception processing, and notifies halt of the reception processing to the user of the reception terminal (step 706).

The setting of reception operation completion may be set by a user, or may be set to be automatically ON when the reception terminal judges left power and the left power is less than a predetermined threshold. Finishing the reception processing enables savings of power consumption corresponding to reception of data, and particularly, is effective in mobile terminals.

Then, program executing section 216 performs authentication of the operation rule (step 707), and when failing the authentication (step 708), finishes the processing (step 709).

By thus performing authentication of the operation rule, the terminal eliminates the improper operation using an improper operation rule.

Meanwhile, when the authentication succeeds, program executing section 216 reads the operation rule to interpret (step 710).

The operation rule describes an event driving of operation rule, and program executing section 216 registers an event (step 711), and when the event occurs (step 712), performs the operation corresponding to the event according to the operation rule (step 713).

Program executing section 216 checks whether an instruction for finishing execution of the program is received (step 714), and when an event does not occur, returns to the processing of step 712.

When program executing section 216 receives the instruction for finishing execution of the program, the section 216 finishes execution of the program (step 715).

In addition, examples as events to occur include timer event (event occurring at the designated time or occurring after a certain time has elapsed), position event (event occurring when the terminal enters or gets out of a designated area), data reception event (event occurring when receiving designated data), and data access event (event occurring when accessing designated data).

When there is no rule to be referred to in step 702, the processing flow shifts to step 711.

Thus, program executing section 216 executes the program.

As described above, according to the first embodiment, server 102 is capable of transmitting to a plurality of distribution areas a program which is common to all the areas, therefore, less-update data whose update is not frequent, and thus, low-update-necessity data whose necessity of update is not high, and further transmitting to each of the areas an operation rule and data for the program which is different for each area, therefore, more-update data whose update is frequent, and thus, high-update-necessity data whose update is needed. By thus transmitting separately a program common to all the areas, and the operation rule and data for the program which is data different for each area, reception terminal 104 is capable of updating only the operation rule and data for the program which is updated frequently with movement of reception terminal 104. Then, by using the program that is already received, reception terminal 104 is capable of keeping the content at the latest state adapted to the current position, without updating the entire content (program, operation rule and data for the program), and maintaining the operating program at the latest state.

In consideration of packet loss occurring on the transmission path, a small amount of data to update as in the first embodiment decreases the time required for receiving all the data completely and thus shortens the reception waiting time.

Further, according to the first embodiment, it is possible to make the transmission cycle of the operation rule and data for the program requiring frequent update shorter than the transmission cycle of the program not requiring frequent update. Thus, reception terminal 104 is capable of quickly receiving the data to update frequently, and performing update of the content smoothly.

In addition, in the first embodiment, content is composed of common data (program) irrespective of the position and data (operation rule and data for the program) varying corresponding to the position. However, content may be composed of common data irrespective of predetermined conditions and condition adapted data adapted to predetermined conditions, and that the server transmits the common data and condition adapted data corresponding to predetermined conditions separately.

Examples considered as predetermined conditions are terminal information, user information and time information.

The common data may be data other than a program, and condition adapted data may be data other than an operation rule and data for the program.

For example, it may be possible that common data that is high-necessity data with a high degree of necessity is set as detailed information of the content, and that condition adapted data that is not needed depending on the condition, i.e., low-necessity data with a low degree of necessity is set as summary information of the content. In this case, as the summary information, dedicated data may be prepared, or it may be possible to use part of media such as text data and static image that composes the content, or a name (program title or a name of a program) Further, in this case, the transmission cycle of the summary information may be shorter than the transmission cycle of the detailed information. In this way, a user is capable of displaying the summary information of content or operating the content in a short waiting time.

### Second Embodiment

The second embodiment describes distributing a program that is the content and a sub-program that is part of the content in a broadcast data distribution in a packet network. The content distribution system according to the second embodiment will be described below.

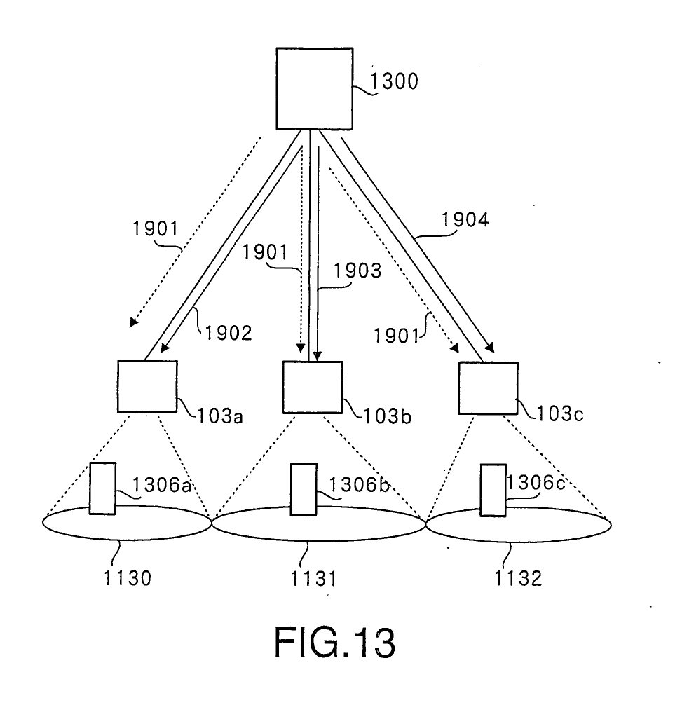

A use mode of the content distribution system according to the second embodiment will be described below with reference to FIG. 13. FIG. 13 is a view showing the use mode of the content distribution system according to the second embodiment. In addition, the same sections as those described already are assigned the same reference numerals to omit specific descriptions.

Server (transmission terminal) 1300 that is a media data transmission apparatus according to the second embodiment transmits data 1 (1901) and data 2 (1902) to relay apparatus 103a, data 1 (1901) and data 3 (1903) to relay apparatus 103b and data 1 (1901) and data 4 (1904) to relay apparatus 103c.

Data 1 (1901) is a main program and is program data common to relay apparatuses 103a to 103c, i.e., common to areas 1130 to 1132. Data 2 (1902), data 3 (1903) and data 4 (1904) is program data different between relay apparatuses 103a to 103c, i.e., between areas 1130 to 1132, and therefore, sub-programs, which are referred to by data 1 (1901).

The program data is assumed to be transmitted repeatedly in a beforehand determined transmission cycle as in DSM-CC.

Server 1300 is assumed to transmit common data as transmission information to relay apparatuses 103a to 103c.

The channel information includes information such as a session tile, session start time, session end time, type of data to transmit as program data, and transmission channel. As a protocol for channel information description, it is assumed to use a protocol for session description, typified by SDP. Specific examples of channel information will be described later. The channel information is also assumed to be transmitted periodically and repeatedly.

In the case of performing such transmission, program data 1901 which is the common data and for example, received in reception area 1130 can be used in reception area 1131. Accordingly, when reception terminal 1306a moves from reception area 1130 to reception area 1131, reception terminal 1306a has little data to update.

Further, in consideration of packet loss occurring on the transmission path, a small amount of data to update results in a short time taken for reception terminals 1306a to 1306c to completely receive all the data, and therefore, decreases the reception waiting time.

In the second embodiment, the transmission cycles of data 2 (1902), data 3 (1903) and data 4 (1904) are set to be shorter than the transmission cycle of data 1 (1901). In this way, when moving, reception terminals 130a to 103c are capable of fast receiving data 2 (1902), data 3 (1903) or data 4 (1903) requiring update, and of decreasing the waiting time for update of the data.

In addition, in the example as described above, the case is described of transmitting data common to areas and data different between the areas. However, it is possible obtain the same effectiveness when programs are divided into those with high update frequency and those with low update frequency in the same area. In this case, by setting a shorter transmission cycle on the program with high update frequency than a transmission cycle on a program with low update frequency, the waiting time for update of the data is further decreased.

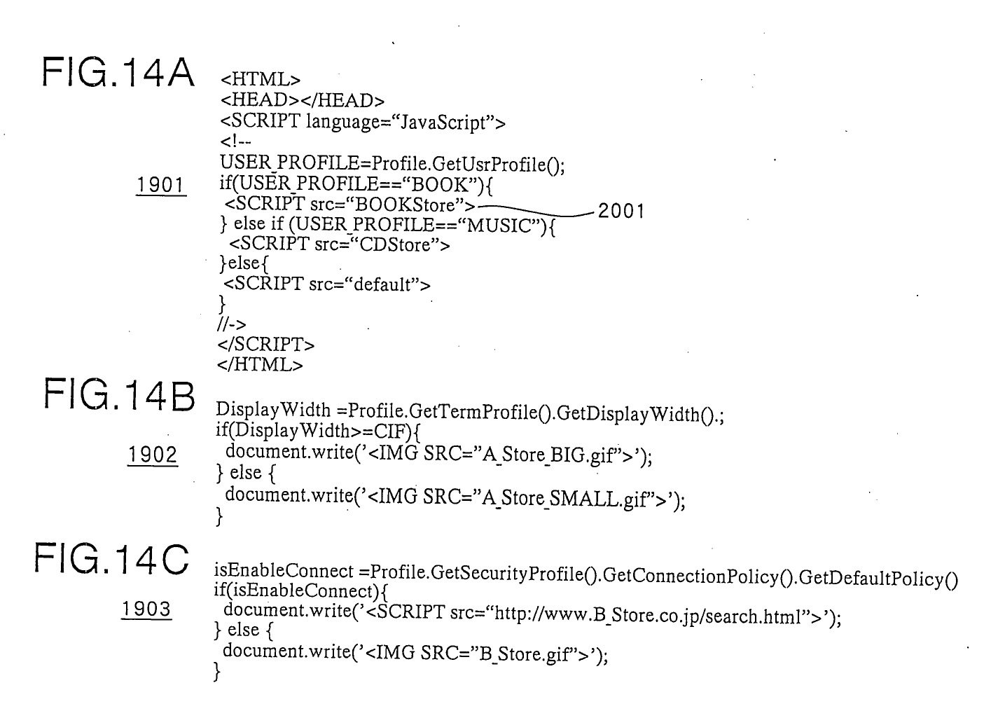

Referring to FIG. 14, data 1901 to 1903 will be described below which server 1300 transmits according to the second embodiment. FIGS. 14A to 14B are views showing data that server 1300 transmits according to the second embodiment.

FIG. 14A shows data 1 (1901), FIG. 14B shows data 2 (1902) and FIG. 14C shows data 3 (1903).

Data 1 (1901) is described to display information of book store when a user profile (that is assumed to be data indicative of subjects of user's interest and stored in the terminal) is acquired and “Book” is registered with the user profile.

A portion denoted by “2001” in the figure instructs to refer to another program, and indicates to acquire a program with a name of “BookStore”. Similarly, in the other portion, when “Music” is registered with the user profile, the portion has descriptions indicative of information of DC shop. When there is any other registration, information of default (program with a name of “default”) is described to be displayed. Such common data being not dependent on areas is distributed in a wide area.

Data 2 (1902) is information of book store “A_Store” (that is a book store closest to the terminal in reception area 1903). Data 2 (1902) acquires the resolution of reception terminal 104, and when the resolution of reception terminal 104 is CIF size or more, displays an image of high resolution. When the resolution of the terminal 104 is less than CIF, data with low resolution is displayed.

Data 3 (1903) is information of bookstore “B_Store”. Data 3 (1903) refers to the security profile set on reception terminal 104, and when the information acquisition by communications is permitted, refers to URL to acquire data. Further, when the information acquisition by communications is not permitted, data 3 (1903) displays image data (“B_Store.gif”) distributed by broadcast.

Since information to present to users is different between stores and the store closest in position is different for each reception area, information described in data 2 (1902) and data 3 (1903) is different for each area and therefore, distributed to respective areas.

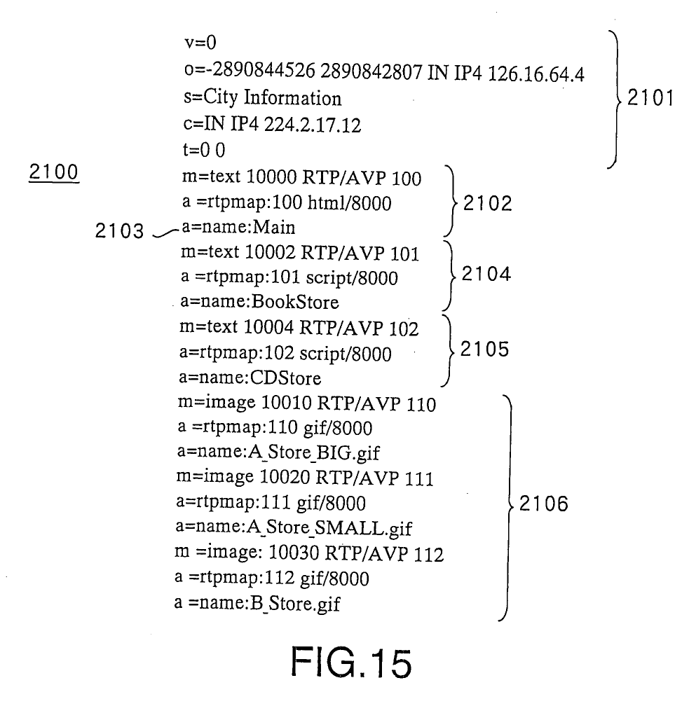

The channel information according to the second embodiment will be described with reference to FIG. 15. FIG. 15 is a view showing the channel information in distributing data according to the second embodiment. The example is described in extended SDP.

A portion denoted by “2101” in channel information 2100 is the same as in conventional SDP, and therefore, indicates transmitting program data to an IP address described in a field of “c=”.

A portion denoted by “2102” in channel information 2100 indicates transmitting HTML to port number 10,000.

A portion denoted by “2103” in channel information 2100 is a field indicative of a name of media data. The name information described in this field is the name of media data illustrated in FIG. 14. In addition, media data described as “Main” in this field is media data that determines a screen structure of the program.

Portions denoted by “2104” and “2105” in channel information 2100 have the same descriptions as described earlier and indicate transmitting the program (Script).

A portion denoted by “2106” in channel information 2100 has descriptions of image data referred to in the program. The image data is distributed to only an area requiring the information.

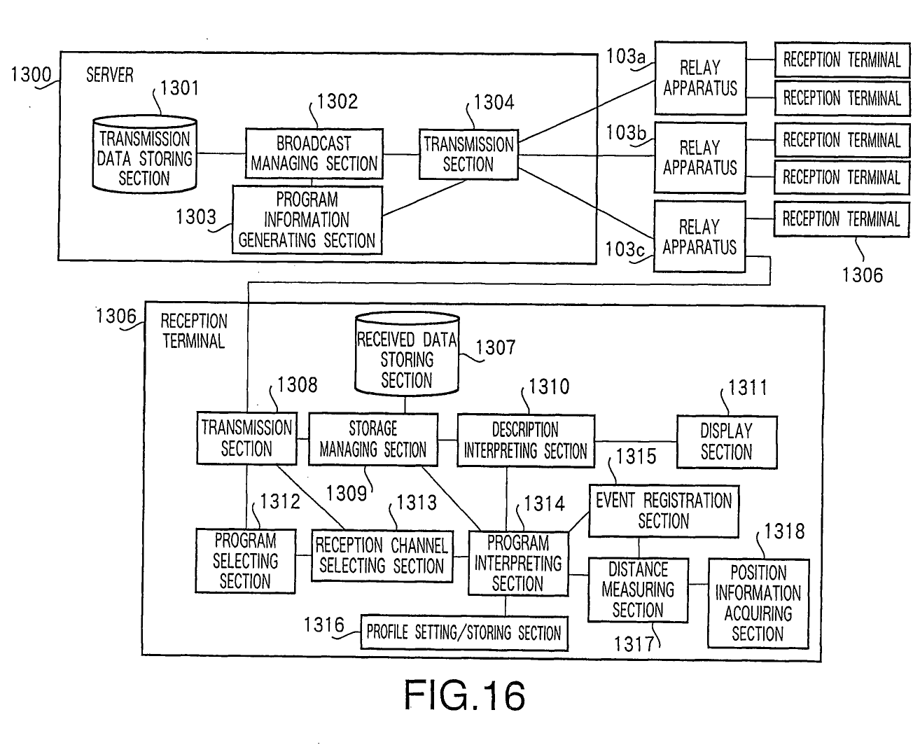

A configuration of the content distribution system according to the second embodiment will be described below with reference to FIG. 16. FIG. 16 is a diagram illustrating the configuration of the content distribution system according to the second embodiment.

In the system, server 1300 transmits the channel information and program data to relay apparatuses 103a to 103c (a plurality of relay apparatuses is available as transmission destinations).

Relay apparatuses 103a to 103c transmit the received data in broadcast or multicast to reception terminals 1306.

It is assumed in the system that each reception terminal 1306 receives channel information on a predetermined common channel (herein, the channel is represented by a pair of destination address and destination port number), and based on the channel on which is transmitted each data described in the channel information, opens the channel, receives the program data (executable content), and presents the information to the user.

In addition, server 1300 is assumed to manage transmission of a plurality of programs.

Server 1300 is comprised of following sections.

Transmission data storing section 1301 is means for storing program data transmitted on networks, and more specifically, is a storage medium typified by a hard disk drive.

Broadcast managing section 1302 is means for managing program broadcast schedules. When it is the beforehand designated time to start broadcast of each program, the section 1302 acquires program data from transmission data storing section 1301 to divide into certain sizes, and transmits the divided data to transmission section 1304.

When it is the end time, broadcast managing section 1302 finishes the transmission of the program data. Further, broadcast managing section 1302 has the function of notifying, at the program transmission start time, information (type of content such as HTML, GIF and JPEG, title of the program, and broadcast start time and end time) of program data of the program whose transmission is started to program information generating section 1303, while notifying, at the program transmission end time, the end of the transmission of the program to the section 1303.

In addition, it may be possible to designate the transmission start time and transmission end time of the program data, file name of data to transmit as the program data using a setting file or using GUI.

Program information generating section 1303 is means for generating channel information of each program based on the information notified from broadcast managing section 1302.

Transmission section 1304 has the interface function of connecting to networks, and further has the function of packetizing data received from broadcast managing section 1302 to transmit to relay apparatuses 103a to 103c. Further, transmission section 1304 sets shorter transmission cycles on data 2 (1902), data 3 (1903) and data 4 (1904) that are sub-programs than the transmission cycle on data 1 (1901) that is the main program. In this way, reception terminals 1306 are capable of fast receiving data 2 (1902), data 3 (1903) and data 4 (1904) requiring update according to areas.

Relay apparatuses 103a to 103c have the function of receiving the channel information and program data transmitted from server 1300 to transfer to networks on which reception terminals 1306 exist. When relay apparatuses 103a to 103b transfer data to networks on the reception terminal 1306 side, the apparatuses are assumed to transmit the data to channels described in the channel information.

More specifically, for example, when the channel information is described in SDP, relay apparatuses 103a to 103c transmit each media data composing the program data to an IP address described in the field of “C=” and a port number described in each field of “m=”.

Reception terminal 1306 is comprised of following sections.

Transmission section 1308 is means for receiving the channel information and program data from relay apparatus 103c to depacketize, and transmitting the data to program selecting section 1312 when the data is the channel information, while transmitting the data to storage managing section 1309 when the data is program data.

Transmission section 1308 has the function of opening a reception channel of the program data by an instruction from reception channel selecting section 1313. Reception channel selecting section 1313 is means for acquiring the data based on URL from a server indicated by the URL when the channel designated is URL.

Program selecting section 1312 has the function of presenting titles of programs to a user among the channel information from transmission section 1308 to cause the user to select a program. Further, when the user selects a program, program selecting section 1312 notifies reception channel selecting section 1313 of the channel information of the selected program.

Reception channel selecting section 1313 is the means for notifying transmission section 1308 of a channel to open, based on the channel on which is transmitted each data described in the channel information. Further, reception channel selecting section 1313 is means for acquiring data based on URL from the server, when receiving URL from program interpreting section 1314.

Storage managing section 1309 stores the received media data in received data storing section 1307. Storage managing section 1309 has the function of combining divided data to notify description interpreting section 1310, when receiving all the divided media data. Further, the section 1309 is means for acquiring a program from the received data to transmit to program interpreting section 1314, when receiving a request from the section 1314.

Description interpreting section 1310 interprets HTML and generates display data. Further, when HTML includes a program such as Java® Script and Java® Applet, description interpreting section 1310 extracts such a portion to transmit to program interpreting section 1314.

Program interpreting section 1314 receives the program notified from description interpreting section 1310 to interpret, and notifies the section 1310 of a result of interpretation. When the program instructs to refer to another program, program interpreting section 1314 requests storage managing section to transmit a reference program.

When the program includes URL, program interpreting section 1314 refers to a security profile (permission of connection to the network) stored in profile setting/storing section 1316. Then, when the access does not violate the security profile, program interpreting section 1314 transmits URL to reception channel selecting section 1313 to instruct to acquire data of URL.

When the program describes registering an event, program interpreting section 1314 refers to the security profile (permission of event registration, and when there is an event on position information, permission of access to position information) stored in profile setting/storing section 1316. When the registration does not violate the security profile, the section 1314 registers the event with event registration section 1315.

When the program describes accessing a user profile, program interpreting section 1314 first refers to the security profile (permission of access to the user profile). When the access does not violate the security profile, program interpreting section 1315 refers to the user profile stored in profile setting/storing section 1316.

When the program describes acquiring position information of a location and current position, program interpreting section 1314 refers to the security profile (permission of access to position information). When the access does not violate the security profile, program interpreting section 1314 acquires the information from distance measuring section 1317.

Display section 1311 is means for presenting a program to a user. More specifically, the section 1311 is displaying means such as CRT and LCD.

Profile setting/storing section 1316 is means for setting and storing terminal profiles, user profiles and security profiles.

Setting of user profile and security profile is performed, for example, using GUI as shown in FIG. 14. In the example, as a user profile, a user places a checkmark in the checkbox of item that is a subject of user's interest, and thereby sets the user profile. With respect to a security profile, a user places a checkmark in the checkbox of item to permit access to the resource (network, file, user profile or position information) in executing the program, and thereby performs the setting.

Position information acquiring section 1318 is means for acquiring a present position of reception terminal 1306. More specifically, the section 1318 is position specifying means using GPS, base station information of cellular telephone or wireless LAN, RF-ID tag, radio signal issued from a wireless beacon, etc. Position information acquiring section 1318 has the function of transmitting acquired position information to distance measuring section 1317.

Distance measuring section 1317 receives the present position information from position information acquiring section 1318, and measures a distance between a location indicated by the position information from event registration section 1315 and the present position. A result of position measurement is transmitted to event registration section 1315.

Event registration section 1315 registers an event according to an event registration instruction from program interpreting section 1314.

Examples registered as events include an timer event (event that occurs after a designated time has elapsed), position event (event that occurs when the terminal enters or gets out of a designated area), data reception event (event that occurs when receiving designated data), and data access event (event that occurs when accessing designated data). The section has the function of calling a function registered in registering the event, when the event occurs.

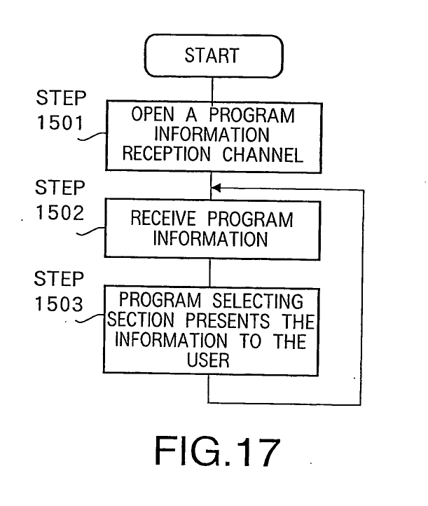

Among the operation in reception terminal 1306 according to the second embodiment, the operation for acquiring channel information to display will be described with reference to FIG. 17. FIG. 17 is an operation flowchart for reception terminal 1306 to acquire channel information to display according to the second embodiment.

First, transmission section 1308 in reception terminal 1306 opens a channel to receive the channel information (step 1501).

It is assumed that the channel is beforehand specified, and that the channel information can be received on the channel always.

Transmission section 1308 receives the transmitted channel information (step 1502) to provide to program selecting section 1312.

Program selecting section 1312 extracts the title information from the channel information to present to a user (step 1503), and then returns the processing of step 1502 to wait for receiving another channel information.

Thus, reception terminal 1306 acquires channel information and displays a program title on display section 1311.

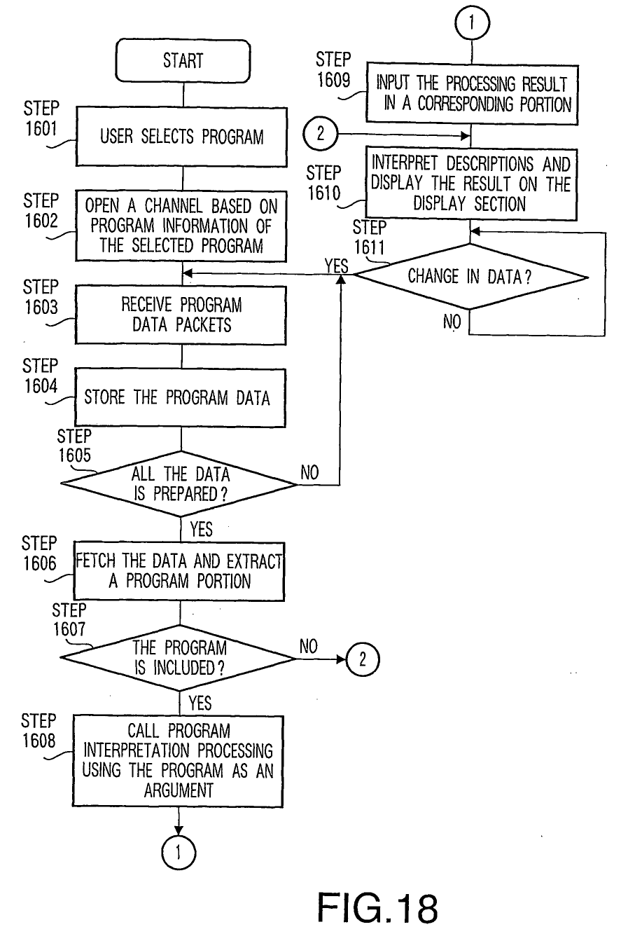

Among the operation in reception terminal 1306, the operation in reception terminal 1306 when a user selects a program will be described with reference to FIG. 18.

FIG. 18 is an operation flowchart after a user of reception terminal 1306 selects a program according to the second embodiment.

When receiving information indicating that the user has selected a program (step 1601), program selecting section 1312 opens a reception channel of each media data based on the channel information of the selected program (step 1602).

Transmission section 1308 receives the program data using the opened channel (step 1603) to output to storage managing section 1309.

Storage managing section 1309 stores media data (HTML data and SMIL data) that determines a screen structure of the program in received data storing section 1307 (step 1604).

When receiving all the media data in step 1604 (step 1605), description interpreting section 1310 fetches the media data, and extracts a program portion to interpret (step 1606).

When the media data includes the program (step 1607), description interpreting section 1310 calls program interpretation processing (described later) by program interpreting section 1314 using the program as an argument (step 1608), and acquires a result of the processing as a return value (step 1609).

Since there is a possibility of communications during a period of time the received media data is displayed, description interpreting section 1310 monitors and waits for update of the media data (step 1611), and when the media data changes, returns to the processing of step 1603 and repeats the processing of acquiring changed media data to display.

In addition, as a method of detecting update of media data, a method is assumed of assigning an identifier that uniquely determines the media data to a header portion of a data packet, and based on a change in the identifier, detecting update.

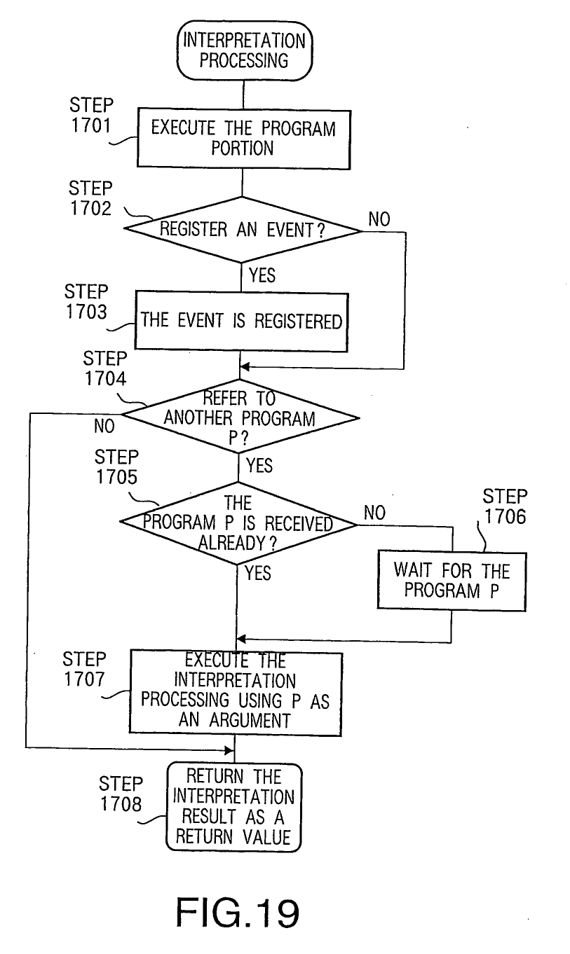

Among the operation in reception terminal 1306, the processing for interpreting a program portion will be described with reference to FIG. 19. FIG. 19 is a flowchart for reception terminal 1306 to interpret a program portion according to the second embodiment.

The interpretation processing is called recursively using as the program as an argument. It is thereby possible to interpret the program of reference structure.

First, program interpreting section 1314 interprets the program provided as an argument (step 1701).

When the program requires event registration (step 1702), program interpreting section 1314 registers the event (step 1703).

When the program has a portion to refer to another program (step 1704), program interpreting section 1314 checks whether the program to be referred to is stored (step 1705). When such a program is not stored, the section 1314 waits for receiving the reference program (step 1706).

Then, program interpreting section 1314 acquires the reference program, and calls the program interpretation processing using the acquired program as an argument (step 1707). Finally, the section 1314 obtains a result of the processing as a return value and finishes the processing (step 1708).

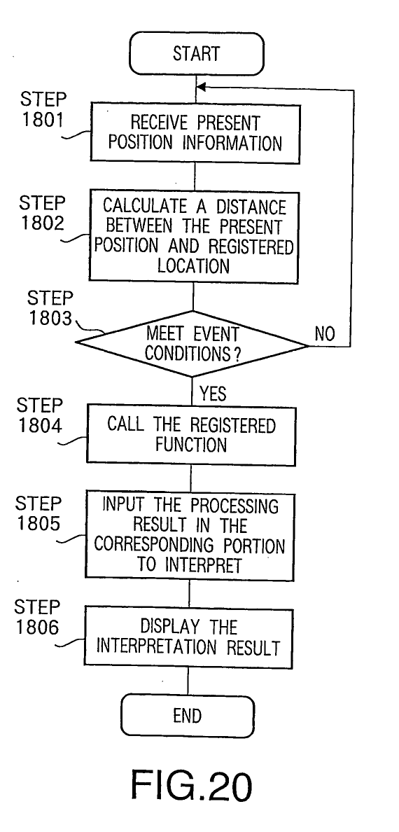

Among the operation in reception terminal 1306, the operation for monitoring a registered event will be described below with reference to FIG. 20. FIG. 20 is an operation flowchart for reception terminal 1306 to monitor a registered event according to the second embodiment.

The example in FIG. 20 illustrates the case where reception terminal 1306 processes a position event.

It is assumed that when reception terminal 1306 registers a position event, the terminal 1306 registers information indicative of a location, information indicative of a distance, type of the position event (indicative of whether the event occurs when entering a region or when getting out of a region) and function to be called when the event occurs.

Position information acquiring section 1318 in reception terminal 1306 receives the present position information (step 1801), and then, distance measuring section 1317 measures a distance between the present position and a location registered in event registration, using the present position information (step 1802).

Program interpreting section 1314 determines whether the result calculated in step 1802 meets event conditions (step 1803), and when the result meets the conditions, returns to the processing of step 1801.

Herein, the event conditions are, for example, that 'a distance between a registered location and the present position is shorter than the distance registered in event registration, and a type of event indicates that the event occurs when entering the region” or “a distance between a registered location and the present position is longer than the distance registered in event registration, and a type of event indicates that the event occurs when getting out of the region”.

When the event conditions are met, program interpreting section 1314 calls the registered function to execute the function (step 1814).

Then, program interpreting section 1314 substitutes the execution result for a corresponding program portion to embed, and executes the interpretation processing (step 1805). Program interpreting section 1314 displays the interpretation result on display section 1311 to finish (step 1806).

As described above, according the second embodiment, in broadcast data distribution in a packet network, it is possible to transmit a program which is common to all the areas, therefore, less-update data, and thus, low-update-necessity data whose necessity of update is low, and sub-programs which are different for each area, therefore, more-update data, and thus, high-update-necessity data whose necessity of update is high, separately. It is thereby possible for reception terminal 1306 to update only sub-programs whose update is frequent with movement of the terminal, and to use the program already stored.

Further, according to the second embodiment, it is possible to make the transmission cycle of the sub-program that is more-update data shorter than the transmission cycle of the program that is less-update program. Thus, reception terminal 1306 is capable of receiving the more-update data quickly, and performing update of the content promptly.

### Third Embodiment

The third embodiment applies the content distribution system in the first embodiment to map distribution.

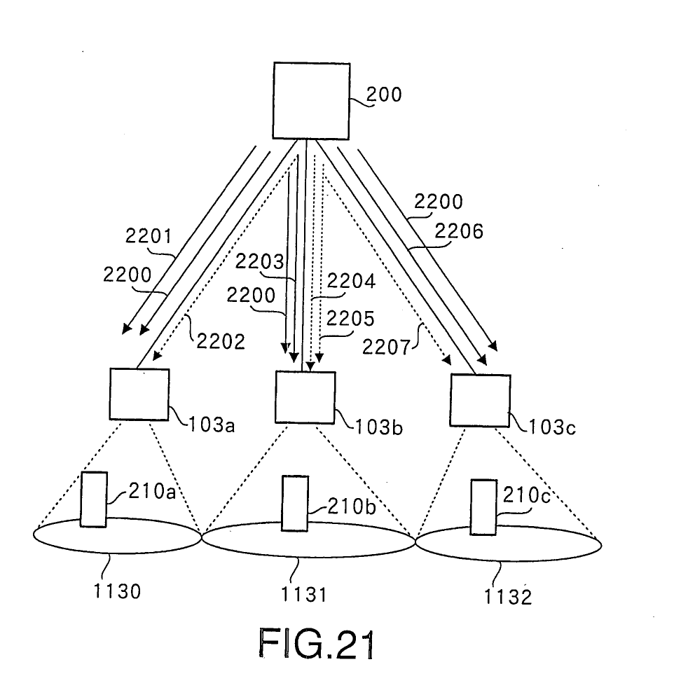

The map distribution system according to the third embodiment will be described below with reference to FIG. 21. FIG. 21 is a view showing a use mode of the map distribution system according to the third embodiment. In addition, the same sections as described already are assigned the same reference numerals.

Relay nodes (relay apparatuses) 103a to 103c respectively distribute map data to distribution areas 1130 to 1132.

Server 200 that is a media data transmission apparatus transmits map data (2201) regarding distribution area 1130 and map data (2202) regarding distribution area 1131 adjacent to distribution area 1130 to relay node 103a, map data (2203) regarding distribution area 1131, map data (2204) regarding distribution area 1130 adjacent to distribution area 1131 and map data (2205) regarding distribution area 1132 adjacent to distribution area 1131 to relay node 103b, and map data (2206) regarding distribution area 1132 and map data (2207) regarding distribution area 1131 adjacent to distribution area 1132 to relay node 103c.

Server 200 distributes program 2200 for displaying a map, which is common data irrespective of areas.

Map data 2201 to 2207 is data for the program with the same Object ID as that of map display program 2200. In this way, since map data 2201 to 2207 has the same Object ID as that of map display program 2200, it is possible to associate the map display program with map data to operate.

Map display program may be distributed using the content distribution system according to this embodiment, downloaded in advance by a user of reception terminal 210 from some URL, instead of being distributed in the content distribution system in this embodiment, or installed from PC through a medium such as a memory card or other various communication media.

It is assumed that server 200 transmits common data as the channel information to relay nodes 103a to 103c. Server 200 sets a short transmission cycle on map data regarding an area where the data is distributed, i.e., high-necessity data with a high degree of necessity, while setting a long transmission cycle on map data of peripheral distribution area, i.e., low-necessity data with a low degree of necessity.

When server 200 thus performs transmission of map data, the waiting time is decreased for the map data regarding the distribution area where reception terminal 210 exists, i.e., for the high-necessity data. It is thereby possible to shorten the time taken to display the map regarding the area where reception terminal 210 is currently present.

As described above, according to the third embodiment, server 200 transmits map data of adjacent areas of areas 1130 to 1132 where reception terminals 210a to 210c are present to reception terminals 210a to 210c, and it is thereby possible for reception terminals 210a to 210c to receive map data regarding other distribution areas 1130 to 1132 in advance, prior to moving to other distribution areas 1130 to 1132 from distribution areas 1130 to 1132. As a result, it is possible for reception terminals 210a to 210c to promptly display map information regarding other distribution areas 1130 to 1132 in moving thereto.

Further, according the third embodiment, even when reception terminal 210 moves, the terminal 210 is capable of using map display program 2200 that is common data irrespective of areas.

In addition, server 200 may set map data regarding the distribution area with reception terminal 201 as detailed map data having a large data amount, while setting map data regarding the adjacent distribution area as simple map data having a smaller data mount than the amount of map data regarding the distribution area with the terminal 201, to distribute.

In this way, reception terminal 210 is capable of displaying a more detailed map concerning the distribution area where the terminal 210 is currently present.

Further in this case, when the simple map data transmitted in an adjacent distribution area is part of the detailed map data transmitted to the distribution area with transmission terminal 210, the terminal 210 is capable of using the map data transmitted in the adjacent distribution area.

For example, when reception terminal 210 moves from distribution area 1130 to distribution area 1131, by only receiving data of a difference between map data 2204 and map data 2202, it is possible to obtain detailed map data regarding distribution are 1131. Accordingly, reception terminal 210 has less data to update, and therefore, is capable of reducing the time taken to display the detailed map.

As a method of receiving difference data in reception terminal 210, it may be possible to check Block No (908 in FIG. 6) of RTP header to store only data that is not received, or to receive only difference map data efficiently in a system which distributes different data 2207 between map data 2204 and map data 2202, and map data 2204 as different programs, or in different ports on the same program, instead of distributing map data 2204 as in FIG. 21.

Further, it may be possible to divide map data to distribute into simple map data of entire distribution areas 1130 to 1132, and detailed map data of each distribution area to distribute. The entire simple map data is distributed over the entire distribution areas 1130 to 1132, while the detailed map data of each distribution area is distributed in the respective area.

Further, in this case, the transmission cycle of the entire simple map data is set to be shorter, while the transmission cycle of the detailed map data for each area is set to be long. In this way, it is possible to use the entire simple map data received in distribution area 1130 in distribution areas 1131 and 1132.

Thus, when the reception terminal moves from distribution area 1130 to distribution area 1131, the terminal is required to only receive the detailed map data of distribution area 1131, and therefore, is capable of reducing the time taken to display the detailed map.

### Fourth Embodiment

The fourth embodiment applies the content distribution system according to the first embodiment to a position-dependent game distribution system.

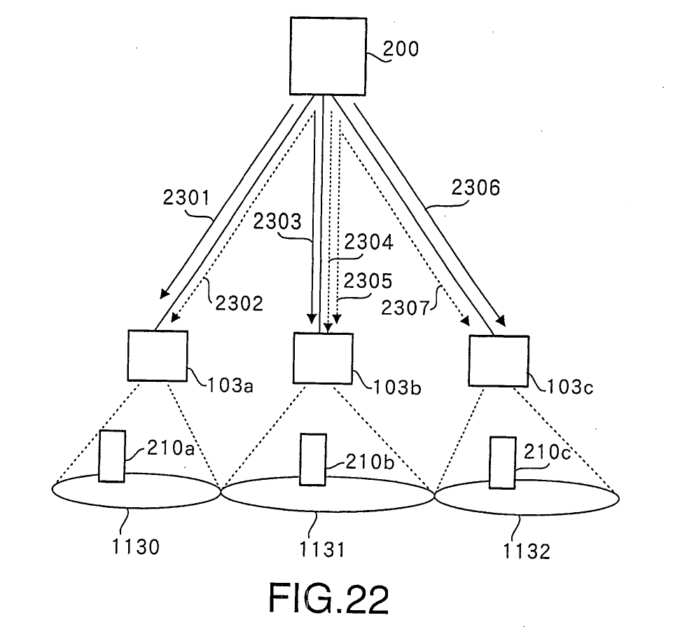

The position-dependent game distribution system according to the fourth embodiment will be described below with reference to FIG. 22. FIG. 22 is a view showing a use mode of the position-dependent game distribution system according to the fourth embodiment. In addition, the same sections as described already are assigned the same reference numerals.

Relay nodes 103a to 103c distribute a main program of a game, rule for specifying the operation of the program, and sub-program or data that the program uses respectively to distribution areas 1130, 1131 and 1132.

Server 200 transmits the main program (2301) of a game that is common data irrespective of areas 1130 to 1132 to relay nodes 103a to 103c, and transmits a rule (2302) used in distribution area 1130 to relay node 103a.

For example, the rule is that “magical skill is lost in distribution area 1130” or “power is twice in distribution area 1130”.

Server 200 transmits data (2303) used in distribution area 1131 to relay node 103b.

The data is information of a character only appearing in distribution area 1131 or map data used in distribution area 1131.

Server 200 transmits a sub-program (2306) used in distribution area 1132 to relay node 103c.

The sub-program is, for example, a program of a casino game enjoyed only in distribution area 1132 or a program for an event occurring only in distribution area 1132.

Rule 2302, data 2303 and sub-program 2306 have the same Object ID as that of main program 2301 of the game, and therefore, are capable of being operated in proper association with the main program of the game.

It is assumed that server 200 transmits common data as the channel information to relay nodes 103a to 103c.

Server 200 sets a long transmission cycle on main program 2301 of the game, while setting a short transmission cycle on rule 2302, data 2303 and sub-program 2306.

When transmission is thus performed, as main program 2301 of the game that is the common data, the program received in distribution area 1130 can be used in distribution areas 1131 and 1132. Accordingly, in distribution areas 1131 and 1132, it is only required to receive data 2303 and 2306 and sub-program 2304 and 2307 for distribution areas 1131 and 1132, and therefore, reception terminals 210a to 210c have less data to update. The reception waiting time is thus decreased. Further, since transmission cycles of data 2303 and 2306 and sub-programs 2304 and 2307 are set to be short, the reception waiting time can be further reduced.

Instead of being distributed using the content distribution system, main program 2301 of the game may be downloaded in advance from some URL, or installed from PC through a medium such as a memory card or other various communication media. Also in this case, the main program of the game, data, rules and sub-programs are associated with one another by having the same Object ID.

As described above, according to the fourth embodiment, it is possible to carry out game distribution corresponding to areas. Further, it is possible to transmit main program 2301 which is common data irrespective of areas, and therefore, less-update data (low-update-necessity data whose necessity of update is low), and rule (2302), data (2303) and sub-program (2306) which are different for each area, and therefore, more-update data (high-update-necessity data whose necessity of update is high), separately. It is thereby possible for reception terminal 210 to use the main program irrespective of areas.

Moreover, according to the fourth embodiment, it is possible to make the transmission cycles of rule (2302), data (2303) and sub-program (2306) which are more-update data shorter than the transmission cycle of main program (2301) that is less-update program. Thus, the reception terminal is capable of receiving rule (2302), data (2303) and sub-program (2306) which are more-update data quickly, and performing update of the content promptly.

### Fifth Embodiment

The fifth embodiment describes operating a program in synchronization with other media (video, audio, static image and text).

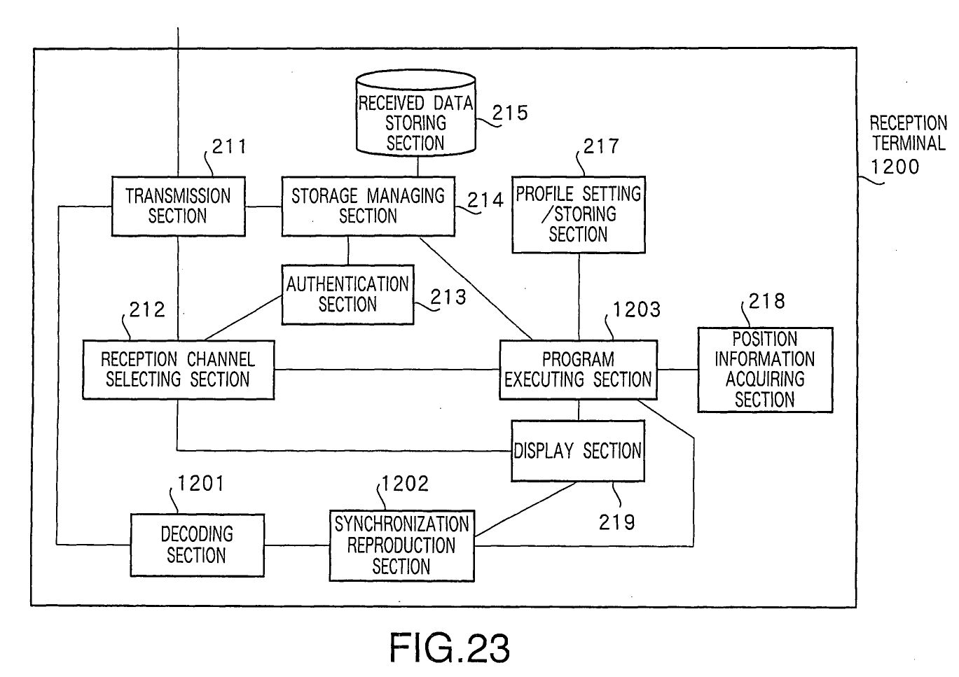

A reception terminal according to the fifth embodiment will be described below with reference to FIG. 23. FIG. 23 is a configuration diagram of a reception terminal according to the fifth embodiment. In addition, the same sections as described already are assigned the same reference numerals.

Reception terminal 1200 according to the fifth embodiment displays content executable in synchronization with other media (video, audio, static image and text).

Reception terminal 1200 has decoding section 1201 and synchronization reproduction section 1202 in addition to the sections in reception terminal 104 according to the first embodiment.

Decoding section 1201 is means for decoding coded information such as video, audio and static image to output to synchronization reproduction section 2102. Further, decoding section 1201 is means for interpreting text data such as HTML when necessary to output to synchronization reproduction section 1202. Furthermore, decoding section 1201 has the function of notifying the program executing section of present reproduction time of content, upon receiving a request from the program executing section.

Synchronization reproduction section 1202 is means for acquiring synchronization of decoded and interpreted data to synthesize. Examples as a synchronization method used in synchronization reproduction section 1202 include a method of assigning a time stamp to transmission data as RTP, and based on the stamp, reproducing data.

Program executing section 1203 has the following function, as well as the function of program executing section 216. When executing a program, program executing section 1203 compares the present content reproduction time with the reproduction time described in the operation rule, and when the reproduction time has gone, handles as a time-out event. When the time-out event occurs, since the program executes the specified operation subsequent thereto, program executing section 1203 is capable of operating the program in synchronization with the display of the content.

As described above, according to the fifth embodiment, even when a single piece of content is divided into a plurality of pieces of media data to be distributed, it is possible to acquire synchronization of the media data to reproduce. By this means, even when a single piece of content is divided into a plurality of pieces of media data to be distributed, it is possible for users of reception terminals to enjoy the content data as in the case of receiving a single piece of content collectively.

This application is based on the Japanese Patent Applications No.2003-014580 filed on Jan. 23, 2003, and No.2003-185529 filed on Jun. 27, 2003, entire contents of which are expressly incorporated by reference herein.

### INDUSTRIAL APPLICABILITY

As described above, according to the present invention, for example, by setting a shorter transmission cycle on media data with high necessity than on media data with low necessity, it is possible to set a shorter transmission cycle on information such as summary information that is a subject of fast viewing than on detailed information. As a result, in a limited transmission band, it is possible to transmit media data so that a reception terminal is capable of updating necessary media data faster when the terminal starts receiving the content or conditions of the reception terminal changes, and to reduce the waiting time for displaying/reproducing the content in the reception terminal. Thus, the present invention is applicable to distribution systems such as a system where a distribution server distributes data to reception terminals in one direction and a broadcast distribution system where reception terminals receive the program.

1. A media data transmission apparatus comprising:
a storage that stores content comprised of first data and second data;
a transmission manager which acquires the first data and the second data from the storage, and sets a shorter transmission cycle on the first data than a transmission cycle on the second data; and
a transmitter that transmits the first data and the second data separately and repeatedly using the set transmission cycles,
wherein the first data is high-necessity data with a high degree of necessity, while the second data is low-necessity data with a low degree of necessity as compared to the high-necessity data.

2. The media data transmission apparatus according to claim 1, wherein the transmission managing section determines at least one of the transmission cycle of the first data and the transmission cycle of the second data based on a size of an area to which the first data is distributed or a size of an area to which the second data is distributed.

3. The media data transmission apparatus according to claim 1, wherein the second data has a larger information amount than that of the first data.

4. The media data transmission apparatus according to claim 1, wherein the first data is data of summary information of the content, while the second data is data of detailed information of the content.

5. The media data transmission apparatus according to claim 4, further comprising:
an electronic signature assigner that assigns an electronic signature to the data of the detailed information,
wherein the transmission manager has the function of assigning a public key certificate to the data of the summary information.

6. The media data transmission apparatus according to claim 1, wherein the high-necessity data and low-necessity data is assigned an identifier that associates the high-necessity data with the low-necessity data and then transmitted.

7. The media data transmission apparatus according to claim 2, wherein the first data is detailed map data of a transmission destination area, while the low-necessity data is rough map data of an area adjacent to the transmission destination area.

8. A media data reception apparatus comprising:
a transmitter that receives the first data and the second data transmitted from the media data transmission apparatus according to claim 1;
a storage manager that associates the first data received and the second data received with each other to store; and
an executor that executes predetermined processing using the second data and the first data associated with the second data.

9. The media data reception apparatus according to claim 8, wherein operation is halted for receiving the first data or the second data in receiving the first data or the second data.

10. The media data reception apparatus according to claim 9, wherein after halting the operation for receiving the first data or the second data, the halt of the operation for receiving is notified to a user.

11. A media data reception apparatus comprising:
a transmitter that receives the data of the summary information and the data of the detailed information transmitted from the media data transmission apparatus according to claim 5;
an authentication section that acquires the public key certificate from the data of the summary information, and the electronic signature from the data of the detailed information, and checks whether the detailed information is tempered using the public key certificate, the data of the detailed information and the electronic signature.

12. A media data reception method, comprising:
receiving the first data and the second data separately transmitted from the media data transmission apparatus according to claim 1;
associating the first data received and the second data received with each other to store; and
performing predetermined processing using the second data and the first data associated with the second data.

13. A media data reception method according to claim 12, wherein when the first data or the second data is received, operation is halted for receiving the first data or the second data.

14. The media data reception method according to claim 13, wherein after halting the operation for receiving the first data or the second data, the halt of the operation for receiving is notified to a user.

15. A content distribution system comprising:
a media data transmission apparatus having:
a storage that stores content comprised of first data and second data;
a transmission manager which acquires the first data and the second data, and sets a shorter transmission cycle of the first data than a transmission cycle on the second data; and
a transmitter that transmits the first data and the second data separately and repeatedly using the set transmission cycles,
and a media data reception apparatus having:
a transmitter that receives the first data and the second data transmitted from the media data transmission apparatus;
a storage manager that associates the first data received and the second data received with each other to store; and
an executor that executes predetermined processing using the second data and the first data associated with the second data,
wherein the first data is high-necessity data with a high degree of necessity, while the second data is low-necessity data with a low degree of necessity as compared to the high-necessity data.
